(19) United States
(12) Patent Application Publication
(10) Pub. No.: US 2025/0236818 A1
(43) Pub. Date: Jul. 24, 2025

(54) HAIR REMOVAL BY MEANS OF DETERGENT/DETERGENT ADDITIVES CONTAINING ENZYMES

(71) Applicant: HENKEL AG & CO. KGAA, Düsseldorf (DE)

(72) Inventors: Shohana ISLAM, Düsseldorf (DE); Susanne WIELAND, Zons/Dormagen (DE); Margret VAN LIER, Hilden (DE); Rainer SORG, Kempen (DE); Lea BERG, Wuppertal (DE); Walter Heberlein, Düsseldorf (DE); Sylvia AUST, Hilden (DE); Ramona JASNY, Mettmann (DE); Christina ROELEKE, Mönchengladbach (DE); Karin KANIA, Mönchengladbach (DE)

(21) Appl. No.: 18/853,394

(22) PCT Filed: Mar. 6, 2023
(86) PCT No.: PCT/EP2023/055603

§ 371 Date: Oct. 1, 2024

(30) Foreign Application Priority Data
Apr. 1, 2022 (DE) 10 2022 107 827.2

(51) Int. Cl. C11D 3/386; C11D 3/39

(52) U.S. Cl. CPC C11D 3/38609; C11D 3/3905; C11D 3/3947; C12Y 304/24011

(57) ABSTRACT

A method for removing hair from textiles using a detergent and/or detergent additive including at least one protease, at least one bleaching agent, and at least one bleach activator is described. Use of a detergent and/or detergent additive including at least one protease, at least one bleaching agent, and at least one bleach activator for removing hair from textiles is also described. Use of a protease for removing hair from textiles is also described.

The present invention relates to a method for removing hair from textiles, wherein in at least one method step a detergent and/or detergent additive containing at least one protease, at least one bleaching agent and at least one bleach activator is used. The present invention also relates to the use of a detergent and/or detergent additive for removing hair from textiles, wherein the detergent and/or detergent additive contains at least one protease, at least one bleaching agent and at least one bleach activator. The invention further relates to the use of a protease for removing hair from textiles.

Pet owners face the problem that a considerable amount of animal hair is usually left on clothing and pet blankets. When such soiled textile items are washed, hair can get stuck in the machine and/or remain caught on items.

Animal hair can be dissolved in the presence of bleaching agents (e.g., sodium percarbonate, sodium carbonate), bleach activators (e.g., tetraacetylethylenediamine (TAED, nonanoyloxybenzenesulfonate (NOBS), dodecanoyloxybenzenesulfonate (LOBS), decanoyloxybenzoic acid (DOBA), Tinocat® TRS KB2 (BASF)) under highly alkaline conditions and at high temperatures (85 to 95° C.) and can therefore be rinsed off more easily. However, this is not practical or energy-efficient nowadays, as consumers generally no longer wash at 85-95° C. or do not want to wash at such high temperatures.

With the existing market solution, such as Vamoosh Pet Hair Dissolver, which has a high alkalinity and also contains bleaching agent and bleach activator, washing must be done at 85 to 95° C. to achieve hair removal during washing.

There is, therefore, still a need for products and methods for washing textile articles that make energy-efficient hair removal possible.

This object is achieved by a method in which in at least one method step a textile detergent and/or textile care agent and/or textile detergent additive is used, wherein the agent and/or additive comprises at least one protease, at least one bleaching agent and at least one bleach activator.

The subject matter of the present invention is therefore firstly a method for removing hair from textiles and/or the interior of a washing machine, wherein in at least one method step a textile detergent and/or textile care agent and/or textile detergent additive containing at least one protease, at least one bleaching agent and at least one bleach activator is used.

In a further aspect, the invention also relates to the use of a textile detergent and/or textile care agent and/or a textile detergent additive for removing hair from textiles and/or the interior of a washing machine, wherein the agent contains at least one protease, at least one bleaching agent and at least one bleach activator.

In another aspect, the invention also relates to the use of a protease for removing hair from textiles and/or the interior of a washing machine, wherein the protease is used in combination with at least one bleaching agent and at least one bleach activator.

These and other aspects, features and advantages of the invention will become apparent to a person skilled in the art through the study of the following detailed description and claims. Any feature from one aspect of the invention can be used in any other aspect of the invention.

This subject matter of the invention includes all conceivable solid and liquid types of detergents and combined products, both concentrates and agents to be used undiluted, for use on a commercial scale, in washing machines or for hand washing. In the context of the invention, the agents also include auxiliary washing agents, which are added to the actual detergent when washing textiles manually or using a machine in order to achieve an additional effect. Furthermore, detergents within the context of the invention also include textile pre-treatment and post-treatment agents, i.e., the agents with which the item of laundry is brought into contact before the actual washing cycle, for example to loosen stubborn stains, and also the agents which give the laundry further desirable conditioning properties, such as a pleasant feel, crease resistance or low static charge in a step subsequent to the actual textile wash.

“At least one” as used herein includes, but is not limited to, 1, 2, 3, 4, 5, 6, and more. In relation to an ingredient, it refers to the type of ingredient and not to the absolute number of molecules. “At least one surfactant” thus means, e.g., at least one type of surfactant, i.e., one type of surfactant or a mixture of a plurality of different surfactants can be meant. Together with weight specifications, the expression relates to all compounds of the type indicated that are contained in the composition/mixture; i.e., the composition does not contain any other compounds of this type beyond the indicated amount of the corresponding compounds.

Unless indicated otherwise, all percentages are indicated in terms of wt. %.

Numeric ranges specified in the format “from x to y” include the specified values. If several preferred numerical ranges are specified in this format, it is readily understood that any ranges resulting from the combination of the various endpoints are also included.

“Approximately” or “approx.” as used herein in connection with a numerical value relates to the numerical value±10%, preferably ±5%.

When reference is made herein to molar masses, this information always refers to the number-average molar mass Mₙ, unless explicitly indicated otherwise. The number-average molar mass can be determined e.g., by gel permeation chromatography (GPC) according to DIN 55672-1:2007-08 with THE as the eluent. The weight-average molar mass Mw can also be determined by means of GPC, as described for Mₙ.

Whenever alkaline earth metals are mentioned in the following as counterions for monovalent anions, this means that the alkaline earth metal is naturally only present in half the amount of substance—sufficient to balance the charge—of the anion.

“Liquid” as used in the context of the present invention denotes all flowable compositions (at 20° C., 1013 bar), including gels and paste-like compositions, and also non-Newtonian liquids that have a yield point.

“Solid”, as used herein, in the context of the present invention denotes a powder composition, granulate composition, extrudate composition or compact composition.

A substance, e.g., a composition or an agent, is solid according to the definition of the invention if it is in a solid state of aggregation at 25° C. and 1,013 mbar.

A substance, e.g., a composition or an agent, is liquid according to the definition of the invention if it is in a liquid state of aggregation at 25° C. and 1,013 mbar. Liquid also includes gel form.

“Phosphate-free” and “phosphonate-free” as used herein mean that the composition in question is substantially free of phosphates or phosphonates, i.e., in particular contains phosphates or phosphonates in amounts of less than 0.1 wt. %, preferably less than 0.01 wt. %, based on the particular composition.

An agent according to the invention can be a single-component agent or a multi-component agent. In the context of the present invention, the term “single-component agent” denotes an agent which consists of only one single component. The term “multi-component agent”, as used herein, denotes, in contrast, an agent which is composed of at least two components. It is preferred that the individual components of a multi-component agent according to the invention are spatially separated from one another.

The expression “spatially separated” in relation to the components of the agent, as used herein, means that the individual components cannot come into contact with one another before the agent is used. Usually, the agent is provided in a multi-chamber packaging, such as a bottle, tube or a pouch, in particular a two-chamber bottle or a two-chamber pouch, with each individual component being located in a separate chamber so as to be separated from the other component(s). The spatial separation of individual components of the agent makes it possible to separate incompatible ingredients from one another and to offer, in combination, several different components of the agent which are used at different times.

In this context, the term “component” denotes a part of the agent that can be distinguished from any further component of the agent on the basis of one or more features, e.g., the type and/or amount of its ingredients, physical properties, external appearance, etc. Individual components of the agent can be present in liquid form, as defined herein, or in solid form, as defined herein, and advantageously spatially separated from one another.

The term “detergent and/or cleaning agent”, “detergent and cleaning agent” or “detergent or cleaning agent” as used herein is synonymous with the term “agent” and denotes a composition for cleaning textiles and/or hard surfaces, in particular dishes, as explained in the description.

The term “textile” as used herein means any textile material, including yarns, yarn precursors, fibers, nonwovens, natural materials, synthetic materials and all other textile materials, fabrics made from these materials, and products made from fabrics (e.g., garments and other articles). The textile or fabric can be in the form of knits, wovens, denims, nonwovens, felts, yarns and terry cloth. The textile can be based on cellulose, for example natural cellulose fibers, such as cotton, flax/linen, jute, ramie, sisal or coconut fibers, or synthetically produced cellulose fibers (e.g., from pulp), such as viscose/rayon, cellulose acetate fibers (Tricell), lyocell or mixtures thereof. The textile or fabric can also consist of non-cellulose fibers, e.g., natural polyamides, such as wool, camel, cashmere, mohair, rabbit hair and silk, or synthetic polymers, such as nylon, aramid, polyester, acrylic, polypropylene and spandex/elastane or mixtures thereof, as well as mixtures of cellulose fibers and non-cellulose fibers. Examples of mixtures are mixtures of cotton and/or rayon/viscose with one or more accompanying materials, such as wool, synthetic fibers (e.g., polyamide fibers, acrylic fibers, polyester fibers, polyvinyl chloride fibers, polyurethane fibers, polyurea fibers, aramid fibers) and/or cellulose fibers (e.g., rayon/viscose, ramie, flax/linen, jute, cellulose acetate fibers, lyocell). The fabric can be conventional washable laundry, e.g., soiled household laundry. When the term “fabric” or “garment” is used, it is intended to include the broader term “textiles.”

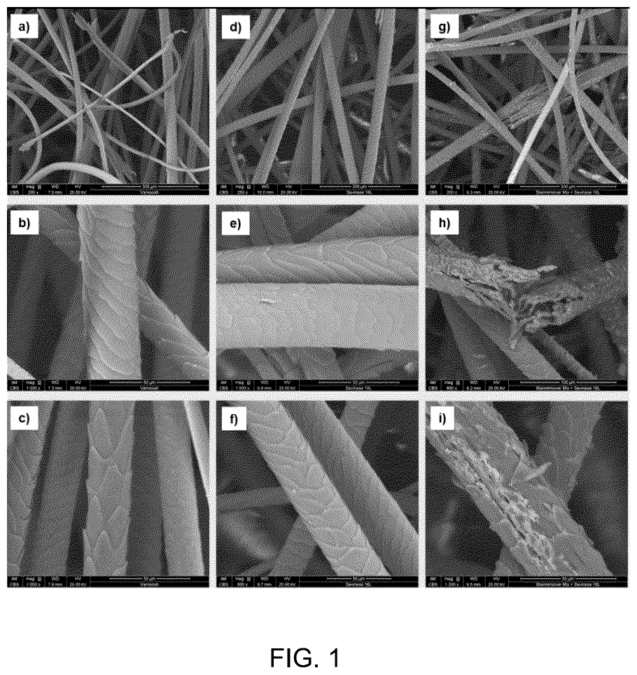

FIG. 1 shows scanning electron micrographs used to evaluate the structure of animal hair after treatment with different detergent formulations during a simulated washing process (according to example 4).

An agent to be used according to the invention comprises at least one protease, at least one bleaching agent and at least one bleach activator.

Proteases suitable in the context of the present invention include all proteases suitable for use in textile detergents and/or textile care agents.

Examples of proteases are the subtilisins BPN′ from Bacillus amyloliquefaciens and Carlsberg from Bacillus licheniformis, protease PB92, subtilisins 147 and 309, the protease from Bacillus lentus, subtilisin DY, and the enzymes thermitase, proteinase K and proteases TW3 and TW7, which in the narrower sense are associated with the subtilases but no longer with the subtilisins. Subtilisin Carlsberg is available in a developed form under the trade name Alcalase® from Novozymes. Subtilisins 147 and 309 are marketed by Novozymes under the trade names Esperase® and Savinase®, respectively. The protease variants marketed under the name BLAP® are derived from the protease from Bacillus lentus DSM 5483. Other proteases that can be used are, for example, the enzymes available under the trade names Durazym®, Relase®, Everlase®, Nafizym®, Natalase®, Kannase® and Ovozyme® from Novozymes, the enzymes available under the trade names Purafect®, Purafect®OxP, Purafect® Prime, Excellase® and Properase® from Danisco/Genencor, the enzyme available under the trade name Protosol® from Advanced Biochemicals Ltd., the enzyme available under the trade name Wuxi® from Wuxi Snyder Bioproducts Ltd., the enzymes available under the trade names Proleather® and Protease P® from Amano Pharmaceuticals Ltd., and the enzyme available under the name Proteinase K-16 from Kao Corp. The proteases from Bacillus gibsonii and Bacillus pumilus, which are disclosed in international patent applications WO 2008/086916 and WO 2007/131656, are also particularly preferably used. Further proteases that can be used advantageously are disclosed in patent applications WO 91/02792, WO 2008/007319, WO 93/18140, WO 01/44452, GB 1243784, WO 96/34946, WO 2002/029024, and WO 2003/057246. Further proteases that can be used are those which are naturally present in the microorganisms Stenotrophomonas maltophilia, in particular Stenotrophomonas maltophilia K279a, Bacillus intermedius and Bacillus sphaericus. Protease variants based on the Bacillus lentus DSM 5483 protease (BLAP), such as those with the R99E substitution, are particularly suitable. Such particularly suitable proteases are described e.g., in WO 2016/096714.

In the context of the present invention, proteases that have keratolytic activity are particularly suitable. In the context of the present invention, the term “having keratolytic activity” means that a corresponding enzyme is capable of breaking peptide bonds (—NH—CO—) of the keratin substrate. Non-limiting examples of commercially available proteases having keratolytic activity include ALCALASE®, SAVINASE®, SAVINASE® ULTRA, SAVINASE® EVITY®, SAVINASE® EVERIS®, ESPERASE® (Novozymes); BLAP™ and BLAP™ variants (Henkel), Valkerase® (BRI Enzymes), KerA (Creative Enzymes). In various embodiments, the at least one protease is correspondingly a protease with keratolytic activity.

In various embodiments, the at least one protease is a keratinase. Within the meaning of the present application, keratinases are proteolytic enzymes that catalyze the cleavage of peptide bonds in proteins. Keratinases fall under the Enzyme Commission Number (EC number) 3.4.21/24/99 and are serine proteases or metalloproteases or proteases with an unknown mechanism of action.

In various embodiments, the at least one protease is correspondingly selected from the group consisting of proteases with keratolytic activity, preferably from the group consisting of keratinases.

Keratinases suitable in the context of the present invention can originate from various organisms. Suitable microorganisms are selected from the group consisting of the genera of Escherichia, Klebsiella, Bacillus, Staphylococcus, Corynebacterium, Arthrobacter, Streptomyces, Stenotrophomonas and Pseudomonas, preferably Bacillus, more preferably Bacillus subtilis or Bacillus cereus. Suitable strains, such as Bacillus subtilis BF11 or Bacillus cereus BF21, are described, for example, in Lakshmi et al. (“Efficient Degradation of Feather by Keratinase Producing Bacillus sp.” in International Journal of Microbiology, Volume 2013, Article ID 608321, pages 1-7).

In various embodiments of the invention, the keratinase used in the detergent according to the invention is a keratinase commercially available under the trade name “KERATOCLEAN® HYDRA PB” micro-granules.

The proteases used herein, which can be keratinases, can be naturally occurring enzymes or enzymes that have been modified by one or more mutations based on naturally occurring enzymes in order to positively influence desired properties, such as catalytic activity or stability.

In the present invention, a genetically modified enzyme can have at least 70%, at least 75%, at least 80%, at least 85%, at least 90%, at least 95%, at least 98% or 100% sequence identity with a naturally occurring parent enzyme over the entire length of the parent protein. In various embodiments, the catalytic activity of a genetically modified enzyme can be at least 70%, at least 75%, at least 80%, at least 85%, at least 90%, at least 95%, at least 98% or 100% of the catalytic activity of the parent enzyme.

The identity of nucleic acid or amino acid sequences is determined by a sequence comparison. This sequence comparison is based on the BLAST algorithm established and commonly used in the prior art (cf. e.g., Altschul et al., “Basic local alignment search tool”, J. Mol. Biol., 1990, 215:403-410, and Altschul et al., “Gapped BLAST and PSI-BLAST: a new generation of protein database search programs”, Nucleic Acids Res., 1997, 25:3389-3402) and occurs in principle by similar sequences of nucleotides or amino acids in the nucleic acid sequences or amino acid sequences being assigned to one another. A tabular assignment of the relevant positions is referred to as an alignment. A further algorithm available in the prior art is the FASTA algorithm. Sequence comparisons (alignments), in particular multiple sequence comparisons, are created using computer programs. The Clustal series (cf. e.g., Chenna et al., “Multiple sequence alignment with the Clustal series of programs”, Nucleic Acid Res., 2003, 31:3497-3500), T-Coffee (cf. e.g., Notredame et al., “T-Coffee: A novel method for multiple sequence alignments”, J. Mol. Biol., 2000, 302:205-217) or programs based on these programs or algorithms, for example, are frequently used. Also possible are sequence comparisons (alignments) using the computer program Vector NTI® Suite 10.3 (Invitrogen Corporation, 1600 Faraday Avenue, Carlsbad, California, USA) with the specified standard parameters, the AlignX module of which for the sequence comparisons is based on ClustalW, or Clone Manager 10 (use of the scoring matrix BLOSUM 62 for sequence alignment at amino acid level). Unless stated otherwise, the sequence identity indicated herein is determined using the BLAST algorithm.

Such a comparison also allows a conclusion to be drawn about the similarity of the compared sequences to one another. It is usually given in percent identity, i.e., the proportion of identical nucleotides or amino acid functional groups at the same positions or positions corresponding to one another in an alignment. In the case of amino acid sequences, the broader concept of homology takes conserved amino acid exchanges into account, i.e., amino acids having similar chemical activity, because these usually perform similar chemical activities within the protein. Therefore, the similarity of the compared sequences can also be indicated as percent homology or percent similarity. Identity and/or homology information can be provided regarding whole polypeptides or genes or only regarding individual regions. Homologous or identical regions of different nucleic acid or amino acid sequences are therefore defined by matches in the sequences. Such regions often have identical functions. They can be small and comprise only a few nucleotides or amino acids. Such small regions often perform essential functions for the overall activity of the protein. It may therefore be expedient to relate sequence matches only to individual, optionally small, regions. Unless otherwise stated, however, identity or homology information in the present application relates to the entire length of the particular nucleic acid or amino acid sequence indicated.

Enzymes that can be used in the context of the present invention can also have amino acid modifications, in particular amino acid substitutions, insertions or deletions, in comparison with the naturally occurring enzymes. Such proteases with keratolytic activity, which can be keratinases, are, for example, developed by targeted genetic modification, i.e., by mutagenesis methods, and optimized for specific applications or with regard to specific properties (for example with regard to their catalytic activity or stability, etc.). Furthermore, nucleic acids encoding the enzymes used can be introduced into recombination approaches and thus used to generate completely new types of enzymes or other polypeptides. The aim is to introduce targeted mutations, such as substitutions, insertions or deletions, into the known molecules in order, for example, to improve the cleaning performance of enzymes according to the invention. For this purpose, in particular the surface charges and/or the isoelectric point of the molecules and thus their interactions with the substrate can be altered. For instance, the net charge of the enzymes can be altered in order to influence the substrate binding, in particular for use in detergents. Alternatively or additionally, the stability of the enzyme can be increased further still by one or more corresponding mutations, thereby improving its cleaning performance. Advantageous properties of individual mutations, e.g., individual substitutions, can complement one another. An enzyme already optimized with regard to certain properties, for example with regard to its activity, can therefore additionally be developed in the context of the invention.

In various embodiments, the agent contains at least one protease as described and defined above, which is characterized in that it is obtained from a protease as described above as starting molecule by single or multiple conservative amino acid substitution. The term “conservative amino acid substitution” means the exchange (substitution) of one amino acid functional group for another amino acid functional group, with this exchange not resulting in a change to the polarity or charge at the position of the exchanged amino acid, e.g., the exchange of a nonpolar amino acid functional group for another nonpolar amino acid functional group. Conservative amino acid substitutions within the context of the invention include, for example: G=A=S, I=V=L=M, D=E, N=Q, K=R, Y=F, S=T, G=A=I=V=L=M=Y=F=W=P=S=T.

Alternatively or additionally, the protease is characterized in that it is obtained from a protease described above as a starting molecule by fragmentation, deletion mutagenesis, insertion mutagenesis or substitution mutagenesis. It is thus possible, for example, to delete individual amino acids at the termini or in the loops of the enzyme without the catalytic activity being lost or reduced as a result. Furthermore, such fragmentation, deletion mutagenesis, insertion mutagenesis or substitution mutagenesis can also, for example, reduce the allergenicity of the enzymes in question and thus improve their overall applicability. Advantageously, the enzymes retain their catalytic activity even after mutagenesis, i.e., their catalytic activity corresponds at least to that of the starting enzyme, i.e., in a preferred embodiment, the catalytic activity is at least 80%, preferably at least 90%, of the activity of the starting enzyme. Further substitutions can also demonstrate advantageous effects. Both individual and multiple contiguous amino acids can be replaced with other amino acids.

It is possible for a person skilled in the art to use methods which are currently generally known, e.g., chemical synthesis or polymerase chain reaction (PCR), in conjunction with molecular biological and/or protein-chemical standard methods, to produce the corresponding nucleic acids and even complete genes on the basis of known DNA and/or amino acid sequences. Such methods are known, e.g., from Sambrook, J., Fritsch, E. F. and Maniatis, T. 2001. Molecular cloning: a laboratory manual, 3rd Edition, Cold Spring Laboratory Press.

In various embodiments of the invention, the protease, as described above, is present in the agent according to the invention in an amount of 1.5 to 20 wt. %, preferably 2.0 to 15 wt. %, more preferably 2.5 to 12 wt. %, even more preferably 3.0 to 10 wt. % active protein, based on the total weight of the agent. Preferably, it is a protease that is substantially free of other proteins and/or other cellular contaminants (e.g., lipids, DNA, RNA, etc.).

The protein concentration can be determined using known methods, for example the BCA method (bicinchoninic acid; 2,2′-bichinolyl-4,4′-dicarboxylic acid) or the Biuret method (Gornall et al., 1948, J. Biol. Chem., 177:751-766). The active protein concentration can be determined in this regard by titrating the active centers using a suitable irreversible inhibitor and determining the residual activity (Bender et al., 1966, J. Am. Chem. Soc. 88 (24): 5890-5913).

The protease can be formulated in forms known for other enzymes used in textile detergents and/or care agents, e.g., in encapsulated form. Corresponding options are known to a person skilled in the art.

In various embodiments of the invention, the agent according to the invention can contain, in addition to the protease or alternatively thereto, a protease-producing microorganism, in particular a microorganism of the genus Bacillus, more preferably Bacillus subtilis or Bacillus cereus, most preferably one or both of the strains described by Lakshmi et al. (supra). In various embodiments of the invention, this microorganism is present in the agent according to the invention in an amount of 2.0 to 20 wt. %, preferably 2.5 to 15 wt. %, based on the total weight of the agent according to the invention.

If, in various embodiments, one or more further enzymes are present in addition to the at least one protease as described above, these are selected from all enzymes suitable for use in textile detergents and/or textile care agents, i.e., one or more further enzymes are selected in particular from the group consisting of lipases, amylases, cellulases, hemicellulases, mannanases, tannases, xylanases, xanthanases, xyloglucanases, β-glucosidases, pectinases, carrageenases, perhydrolases, oxidases, and oxidoreductases, and mixtures thereof. The amount of further enzyme is advantageously 1×10⁻⁸ to 5 wt. %, based on active protein, in particular from 1×10⁻⁷ to 3 wt. %, from 0.00001 to 1 wt. %, from 0.00005 to 0.5 wt. %, from 0.0001 to 0.1 wt. % and particularly preferably from 0.0001 to 0.05 wt. %, in each case based on the total weight of the agent and based on active protein. If the at least one protease is a protease with keratolytic activity and/or a keratinase, an agent as described herein can additionally comprise further proteases. In such embodiments, the at least one protease with keratolytic activity and/or keratinase is present in the amounts defined above, i.e., in amounts of 1.5 to 20 wt. %, preferably 2.0 to 15 wt. %, more preferably 2.5 to 12 wt. %, even more preferably 3.0 to 10 wt. % active protein, based on the total weight of the agent, and the at least one further protease, i.e., a protease that has no keratolytic activity, is present in the usual amounts, i.e., for example, in amounts of 1×10⁻⁸ to 1 wt. %, each based on the total weight of the agent and based on active protein.

Particularly preferably, the enzymes used exhibit synergistic cleaning performance with respect to particular dirt or stains, i.e., the enzymes present in the agent composition assist one another in their cleaning performance. Very particularly preferably, there is such synergism between a protease and a further enzyme of an agent according to the invention, including in particular between a protease and an amylase and/or a lipase and/or a mannanase and/or a cellulase and/or a pectinase. Synergistic effects can occur not only between different enzymes but also between one or more enzymes and other ingredients of the agent according to the invention.

The enzymes possibly to be used additionally in the context of the present invention can originate, for example, from microorganisms, for example of the genera Bacillus, Streptomyces, Humicola or Pseudomonas, and/or can be produced by suitable microorganisms using biotechnological methods that are known per se, for example by transgenic expression hosts, for example of the genera Escherichia, Bacillus, or by filamentous fungi.

It is emphasized that in particular technical enzyme preparations of the relevant enzyme can also be involved, i.e., that accompanying substances can be present. Therefore, the enzymes can be packaged and used together with accompanying substances, for example from fermentation or with other stabilizers.

The enzymes are generally not provided in the form of the pure protein, but rather in the form of stabilized, storable and transportable preparations. These pre-packaged preparations include, for example, the solid preparations obtained through granulation, extrusion, or lyophilization or, in particular in the case of liquid or gel agents, solutions of the enzymes, which are advantageously maximally concentrated, have a low water content, and/or are supplemented with stabilizers or other auxiliaries.

Alternatively, the enzymes can also be encapsulated, for both the solid and the liquid administration form, e.g., by spray-drying or extrusion of the enzyme solution together with a preferably natural polymer or in the form of capsules, e.g., those in which the enzymes are enclosed in a set gel, or in those of the core-shell type, in which an enzyme-containing core is coated with a water-, air-, and/or chemical-impermeable protective layer. Other active ingredients such as stabilizers, emulsifiers, pigments, bleaching agents, or dyes can additionally be applied in overlaid layers. Such capsules are applied using methods that are known per se, for example by shaking or roll granulation or in fluidized bed processes. Advantageously, such granules are low in dust, for example due to the application of polymeric film-formers, and stable in storage due to the coating.

Furthermore, it is possible in particular to package two or more enzymes together such that a single granulate exhibits a plurality of enzyme activities, as explained above.

An enzyme-containing formulation as described above usually contains the at least one enzyme in an amount of 0.1 to 50 wt. %, preferably 0.1 to 20 wt. %, based on the total weight of the formulation.

In liquid formulations, the enzymes are preferably used as liquid enzyme formulation(s). In various embodiments, such a liquid enzyme-containing formulation contains at least one organic solvent, preferably selected from alcohols, particularly preferably polyhydric alcohols that are liquid under standard conditions (20° C., 1013 mbar), in particular glycerin, 1,2-propanediol and sorbitol, and mixtures thereof. If these are present, the amount is preferably from 0.1 to 99.9 wt. %, more preferably 10 to 90 wt. %, based on the total weight of the enzyme-containing formulation.

Bleaching agents suitable in the context of the present invention, i.e., those which are suitable for use in textile washing methods and/or textile care methods and in correspondingly suitable agents, or which are usually used in such, are known in the prior art. Suitable bleaching agents generally include hypochlorites, hydrogen peroxide or hydrogen peroxide-producing substances.

In various embodiments, however, it is preferred for the at least one bleaching agent not to be a chlorine-containing bleaching agent.

In various embodiments, the at least one bleaching agent is present in an amount of 5 to 70 wt. %, preferably in an amount of up to 50 wt. %, in particular of up to 40 wt. % and particularly preferably of 7 to 30 wt. %, in each case based on the total weight of the agent.

In various embodiments, the at least one bleaching agent is a peroxygen-based bleaching agent. Peroxygen-based bleaching agents are advantageously present in amounts in the range of from 5 to 70 wt. %, in particular from 5 to 30 wt. %, in each case based on the total weight of the agent.

The bleaching agents in question are preferably the peroxygen compounds generally used in detergents, such as percarboxylic acids, e.g., dodecanedioic acid or phthaloylaminoperoxicaproic acid, hydrogen peroxide, alkali metal perborate, which can be in the form of tetra- or monohydrate, percarbonate, perpyrophosphate and persilicate, which are generally used as alkali metal salts, in particular as sodium salts. Photobleach, such as tetrabenzotetraazoporphyrins or similar, is also suitable. Such bleaching agents are preferably present in amounts of up to 70 wt. %, e.g., in amounts of approximately 1, 2, 3, 4, 5, 6, 7, 8, 9, 10, 11, 12, 13, 14, 15, 16, 17, 18, 19, 20, 25, 30, 35, 40, 45, 50, 55, 60, 65 or 70 wt. %, in particular up to 50 wt. %, more preferably up to 40 wt. %, and particularly preferably from 7 wt. % to 30 wt. %, in each case based on the total weight of the agent in question, with percarbonate being used in particular. If solid peroxygen compounds are intended to be used, these may be used in the form of powders or granules, which may also be coated in a manner known in principle. The addition of small amounts of known bleaching agent stabilizers, such as phosphonates, borates or metaborates, metasilicates, and magnesium salts, such as magnesium sulfate, may be expedient.

The amount of bleach activator is preferably up to 17 wt. %, in particular 0.3 wt. % to 15 wt. %, based on the total weight of the agent.

Bleach activators suitable in the context of the present invention include all known and commonly used bleach activator compounds.

In particular, compounds which produce, under perhydrolysis conditions, optionally substituted perbenzoic acid and/or aliphatic peroxycarboxylic acids having 1 to 12 C atoms, in particular 2 to 4 C atoms, alone or in mixtures, can be used as a bleach activator compound that yields peroxycarboxylic acid under perhydrolysis conditions. Bleach activators that have O- and/or N-acyl groups in particular of the stated number of C atoms and/or optionally substituted benzoyl groups are suitable. Preferred are polyacylated alkylenediamines, in particular tetraacetylethylenediamine (TAED), acylated glycolurils, in particular tetraacetylglycoluril (TAGU), acylated triazine derivatives, in particular 1,5-diacetyl-2,4-dioxohexahydro-1,3,5-triazine (DADHT), N-acylimides, in particular N-nonanoylsuccinimide (NOSI), acylated phenol sulfonates or carboxylates or the sulfonic or carboxylic acids thereof, in particular nonanoyl or isononanoyl or lauroyl oxybenzene sulfonate (NOBS or iso-NOBS or LOBS) or decanoyloxybenzoate (DOBA), the formal carbonic acid ester derivatives thereof, such as 4-(2-decanoyloxyethoxycarbonyloxy)benzene sulfonate (DECOBS), acylated polyhydric alcohols, in particular triacetin, ethylene glycol diacetate and 2,5-diacetoxy-2,5-dihydrodrofuran and acetylated sorbitol and mannitol and mixtures thereof (SORMAN), acylated sugar derivatives, in particular pentaacetylglucose (PAG), pentaacetylfructose, tetraacetylxylose and octaacetyl lactose, acetylated, optionally N-alkylated glucamine and gluconolactone, and/or N-acylated lactams, e.g., N-benzoyl-caprolactam.

Additionally or alternatively to compounds that form peroxycarboxylic acids under perhydrolysis conditions, further bleach activator compounds, such as nitriles, from which perimidic acids form under perhydrolysis conditions, can be present. These include in particular aminoacetonitrile derivatives having a quaternized nitrogen atom according to formula (I)

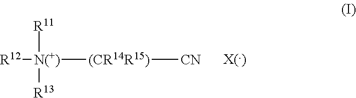

in which R¹¹ represents —H, —CH₃, a C₂₋₂₄ alkyl or alkenyl functional group, a substituted C₁₋₂₄ alkyl or C₂₋₂₄ alkenyl functional group having at least one substituent from the group —Cl, —Br, —OH, —NH₂, —CN and —N⁽⁺⁾—CH₂—CN, an alkyl or alkenylaryl functional group having a C₁₋₂₄ alkyl group, or a substituted alkyl or alkenylaryl functional group having at least one, preferably two, optionally substituted C₁₋₂₄ alkyl group(s) and optionally further substituents on the aromatic ring, R¹² and R¹³ are selected, independently of one another, from —CH₂—CN, —CH₃, —CH₂—CH₃, —CH₂—CH₂—CH₃, —CH(CH₃)—CH₃, —CH₂—OH, —CH₂—CH₂—OH, —CH(OH)—CH₃, —CH₂—CH₂—CH₂—OH, —CH₂—CH(OH)—CH₃, —CH(OH)—CH₂—CH₃, —(CH₂CH₂—O)ₙH, where n=1, 2, 3, 4, 5 or 6, R¹⁴ and R¹⁵ have, independently of one another, the meaning specified above for R¹¹, R¹² or R¹³, wherein at least two of the functional groups mentioned, in particular R¹² and R¹³, also including the nitrogen atom and optionally further heteroatoms, can be linked to one another in a ring-closing manner and then preferably form a morpholine ring, and X is a charge-balancing anion, preferably selected from benzene sulfonate, toluene sulfonate, cumene sulfonate, the C₉₋₁₅ alkylbenzene sulfonates, the C₁₋₂₀ alkyl sulfates, the C₈₋₂₂ carboxylic acid methyl ester sulfonates, sulfate, hydrogen sulfate, and mixtures thereof. Oxygen-transferring sulfonimines can also be used.

The amount of such bleach activators, i.e., the bleach activator compounds that provide peroxocarboxylic acid under perhydrolysis conditions and the bleach activator compounds that form perimidic acids under perhydrolysis conditions, is preferably 0.3 to 14 wt. %, preferably up to 12 wt. %, in particular from 1 to 12 wt. %, e.g. 1, 2, 3, 4, 5, 6, 7, 8, 9, 10, 11 or 12 wt. %, in each case based on the total weight of the agent in question.

The bleach activators may have been coated or granulated in a known manner with coating substances during storage in order to avoid interaction with the peroxygen compounds, wherein tetraacetylethylenediamine granulated using carboxymethylcellulose and having an average particle size of from 0.01 to 0.8 mm, granulated 1,5-diacetyl-2,4-dioxohexahydro-1,3,5-triazine, and/or trialkylammonium acetonitrile in particulate form is particularly preferred.

In addition to such bleach activators or, if desired, instead of them, conventional bleach-activating transition metal complexes can also be used as bleach activators. These are preferably selected from the cobalt, iron, copper, titanium, vanadium, manganese and ruthenium complexes. Suitable ligands in such transition metal complexes are both inorganic and organic compounds, which include, in addition to carboxylates, in particular compounds having primary, secondary and/or tertiary amine and/or alcohol functions, such as pyridine, pyridazine, pyrimidine, pyrazine, imidazole, pyrazole, triazole, 2,2′-bispyridylamine, tris-(2-pyridylmethyl)amine, 1,4,7-triazacyclononane and the substituted derivatives thereof, such as 1,4,7-trimethyl-1,4,7-triazacyclononane, 1,5,9-triazacyclododecane, and the substituted derivatives thereof, such as 1,5,9-trimethyl-1,5,9-triazacyclododecane, 1,4,8,11-tetraazacyclotetradecane and the substituted derivatives thereof, such as 5,5,7,12,12,14-hexamethyl-1,4,8,11-tetraazacyclotetradecane, 1,5,8,12-tetraazabicyclo[6.6.2]hexadecane, and the substituted derivatives thereof, such as 5,12-diethyl-1,5,8,12-tetraazabicyclo[6.6.2]hexadecane, (bis-((1-methylimidazole-2-yl)-methyl))-(2-pyridylmethyl)-amine, N,N′-(bis-(1-methylimidazole-2-yl)-methyl)-ethylenediamine, N-bis-(2-benzimidazolylmethyl)aminoethanol, 2,6-bis-(bis-(2-benzimidazolylmethyl)aminomethyl)-4-methylphenol, N,N,N′,N′-tetrakis-(2-benzimidazolylmethyl)-2-hydroxy-1,3-diaminopropane, 2,6-bis-(bis-(2-pyridylmethyl)aminomethyl)-4-methylphenol, 1,3-bis-(bis-(2-benzimidazolylmethyl)aminomethyl) benzene, sorbitol, mannitol, erythritol, adonitol, inositol, lactose, and optionally substituted salens, porphins and porphyrins. The inorganic neutral ligands include in particular ammonia and water. If not all coordination sites of the transition metal central atom are occupied by neutral ligands, the complex contains further, preferably anionic, ligands, of these in particular mono- or bidentate ligands. These include in particular the halides, such as fluoride, chloride, bromide and iodide, and the (NO₂)⁻ group, i.e. a nitro ligand or a nitrito ligand. The (NO₂)⁻ group can also be chelated to a transition metal or it can asymmetrically bridge or η¹-O-bridge two transition metal atoms. In addition to the ligands mentioned, the transition metal complexes may carry further, generally more simple ligands, in particular mono- or polyvalent anion ligands. For example, nitrate, acetate, trifluoroacetate, formate, carbonate, citrate, oxalate, perchlorate, and complex anions, such as hexafluorophosphate, are suitable. The anion ligands are intended to ensure charge balance between the transition metal central atom and the ligand system. The presence of oxo ligands, peroxo ligands and imino ligands is also possible. In particular, such ligands can also have a bridging effect, such that polynuclear complexes are produced. In the case of bridged, binuclear complexes, the two metal atoms in the complex do not need to be the same. The use of binuclear complexes in which the two transition metal central atoms have different oxidation numbers is also possible. If anion ligands are missing or the presence of anionic ligands does not result in charge balance in the complex, anionic counterions which neutralize the cationic transition metal complex are present in the transition metal complex compounds to be used according to the invention. These anionic counterions include in particular nitrate, hydroxide, hexafluorophosphate, sulfate, chlorate, perchlorate, the halides, such as chloride, or the anions of carboxylic acids, such as formate, acetate, oxalate, benzoate or citrate. Examples of transition metal complex compounds that can be used are Mn(IV)₂(μ-O)₃(1,4,7-trimethyl-1,4,7-triazacyclononane)-di-hexafluorophosphate, [N,N′-bis[(2-hydroxy-5-vinylphenyl)-methylene]-1,2-diaminocyclohexane]-manganese(III) chloride, [N,N′-bis[(2-hydroxy-5-nitrophenyl)methylene]-1,2-diaminocyclohexane]-manganese(III) acetate, [N,N′-bis[(2-hydroxyphenyl)methylene]-1,2-phenylenediamine]-manganese(III) acetate, [N,N′-bis[(2-hydroxyphenyl)methylene]-1,2-diaminocyclohexane]-manganese(III) chloride, [N,N′-bis[(2-hydroxyphenyl)methylene]-1,2-diaminoethane]-manganese(III) chloride, [N,N′-bis[(2-hydroxy-5-sulfonatophenyl)methylene]-1,2-diaminoethane]-manganese(III) chloride, manganese oxalate complexes, nitropentammine cobalt(III) chloride, nitritopentammine cobalt(III) chloride, hexammine cobalt(III) chloride, chloropentammine cobalt(III) chloride and the peroxo complex [(NH₃)₅Co—O—O—Co(NH₃)₅]Cl₄.

In detergents or cleaning agents, bleach-activating transition metal complexes (e.g., hydrazinylmethylmorpholinium chloride, Mn-salen complex) are preferably present in amounts of up to 0.5 wt. %, in particular from 0.0005 to 0.2 wt. %, in each case based on total agent.

In addition to and/or instead of the aforementioned bleach activators, acylhydrazones of general formula (II) can be used,

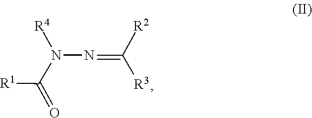

where R¹ represents a CF₃ group or a C₁₋₂₈ alkyl, C₂₋₂₈ alkenyl, C₂₋₂₂ alkinyl, C₃₋₁₂ cycloalkyl, C₃₋₁₂ cycloalkenyl, phenyl, naphthyl, C₇₋₉ aralkyl, C₃₋₂₀ heteroalkyl or C₃₋₁₂ cycloheteroalkyl group, which can optionally be substituted, R² and R³ represent, independently of one another, hydrogen or an optionally substituted C₁₋₂₈ alkyl, C₂₋₂₈ alkenyl, C₂₋₂₂ alkinyl, C₃₋₁₂ cycloalkyl, C₃₋₁₂ cycloalkenyl, C₇₋₉ aralkyl, C₃₋₂₈ heteroalkyl, C₃₋₁₂ cycloheteroalkyl, C₅₋₁₆ heteroaralkyl, phenyl, naphthyl or heteroaryl group, or R² and R³, together with the carbon atom which connects them, represent an optionally substituted 5-, 6-, 7-, 8- or 9-membered ring, which can optionally contain heteroatoms, and R⁴ represents hydrogen or a C₁₋₂₈ alkyl, C₂₋₂₈ alkenyl, C₂₋₂₂ alkinyl, C₃₋₁₂ cycloalkyl, C₃₋₁₂ cycloalkenyl, C₇₋₉ aralkyl, C₃₋₂₀ heteroalkyl, C₃₋₁₂ cycloheteroalkyl, C₅₋₁₆ heteroaralkyl group or an optionally substituted phenyl or naphthyl or heteroaryl group. The acylhydrazones can exist in E or Z configuration; when R² is hydrogen, the compound of general formula (II) can be in one of its tautomeric forms or as a mixture thereof.

In the compounds of general formula (II), R² is preferably hydrogen. R¹ and/or R³ is preferably an alkyl, phenyl or naphthyl group substituted with an electron-withdrawing group. R⁴ is preferably hydrogen. The electron-withdrawing group is preferably an ammonium group, which optionally carries alkyl groups or hydroxyalkyl groups or is formed as a heterocycloalkyl group, which optionally carries further heteroatoms, including the N atom carrying an alkyl group.

Preferred embodiments of the compounds according to general formula (II) include those of general formula (III),

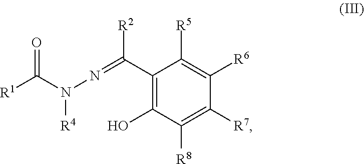

where R¹ a C₁₋₄ alkyl group, which carries a substituent selected from

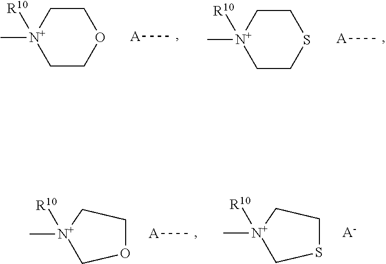

where R¹⁰ represents hydrogen or a C₁₋₂₈ alkyl, C₂₋₂₈ alkenyl, C₂₋₂₂ alkinyl, C₃₋₁₂ cycloalkyl, C₃₋₁₂ cycloalkenyl, C₇₋₉ aralkyl, C₃₋₂₀ heteroalkyl, C₃₋₁₂ cycloheteroalkyl, C₅₋₁₆ heteroaralkyl group, and A⁻ represents the anion of an organic or inorganic acid, R² and R⁴ have the meaning indicated for formula (II), and R⁵, R⁶, R⁷ and R⁸ represent, independently of one another, R¹, hydrogen, halogen, a hydroxy, amino, an optionally substituted N-mono or di-C₁₋₄ alkyl or C₂₋₄ hydroxyalkylamino, N-phenyl or N-naphthylamino, C₁₋₂₈ alkyl, C₁₋₂₈ alkoxy, phenoxy, C₂₋₂₈ alkenyl, C₂₋₂₂ alkinyl, C₃₋₁₂ cycloalkyl, C₃₋₁₂ cycloalkenyl, C₇₋₉ aralkyl, C₃₋₂₀ heteroalkyl, C₃₋₁₂ cycloheteroalkyl, C₅₋₁₆ heteroaralkyl, phenyl or naphthyl group, wherein the substituents are selected from C₁₋₄ alkyl, C₁₋₄ alkoxy, hydroxy, sulfo, sulfato, halogen, cyano, nitro, carboxy, phenyl, phenoxy, naphthoxy, amino, N-mono or di-C₁₋₄ alkyl or C₂₋₄ hydroxyalkylamino, N-phenyl or N-naphthylamino groups, or R⁵ and R⁶ or R⁶ and R⁷ or R⁷ and R⁸ are interconnected to form 1, 2 or 3 carbocyclic or O-, NR¹⁰- or S-heterocyclic, optionally aromatic and/or optionally C₁₋₆ alkyl-substituted rings.

The anion A⁻ is preferably carboxylate, such as lactate, citrate, tartrate or succinate, perchlorate, tetrafluoroborate, hexafluorophosphate, alkylsulfonate, arylsulfonate, such as p-toluenesulfonate, alkyl sulfate, such as methosulfate, hydrogen sulfate, sulfate, dihydrogen phosphate, hydrogen phosphate, phosphate, isocyanate, thiocyanate, nitrate, fluoride, chloride, bromide, hydrogen carbonate or carbonate, wherein in the case of multivalent anions the charge balance can be achieved by the presence of additional cations, such as sodium or ammonium ions.

Particularly preferred is the acylhydrazone of formula (IV),

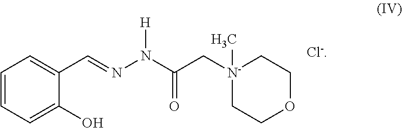

Acylhydrazones of the general formulas (II), (III) or (IV) are preferably used in amounts of 0.001 to 5 wt. %, in particular 0.05 to 0.15 wt. % in the agents described herein.

In various embodiments, at least one bleach activator is used. In various embodiments, the at least one bleach activator is selected from the group consisting of bleach activator compounds that yield peroxocarboxylic acid under perhydrolysis conditions; bleach activator compounds that form perimidic acid under perhydrolysis conditions; bleach-activating transition metal complexes and acylhydrazones. In various embodiments, it may be advantageous to use mixtures of different bleach activators, e.g., at least two different bleach activators in combination, wherein the different bleach activators are preferably selected from the above-described groups of bleach activator compounds that yield peroxocarboxylic acid under perhydrolysis conditions, bleach activator compounds that form perimidic acid under perhydrolysis conditions, bleach-activating transition metal complexes and acylhydrazones.

The total amount of bleach activators is preferably up to 17 wt. %, in particular 0.3 to 15 wt. %, more preferably up to 13 wt. %, in particular from 1 to 12 wt. %, e.g., 1, 2, 3, 4, 5, 6, 7, 8, 9, 10, 11 or 12 wt. %, in each case based on the total weight of the agent in question.

In various embodiments, the weight ratio of bleaching agent to bleach activator is approximately 5:1 to 15:1, preferably approximately 8:1 to 12:1, e.g., approximately 10:1.

An agent as described herein can be a liquid or a solid product. However, since the agents described here can also be multi-component agents, combination products are also possible, i.e., products containing both liquid and solid components or formulations.

In some embodiments, a textile detergent and/or textile care agent or textile detergent additive and/or textile care agent additive as described herein is in the form of a concentrate. Concentrates are known in the prior art and are expressly covered by the subject matter of the present invention. Suitable concentrates can in particular be in the form of a gel-like or pasty, preferably low-water or substantially water-free formulation.

In various embodiments, a textile detergent and/or textile care agent or textile detergent additive and/or textile care agent additive as described herein is in the form of a solid agent, in particular in powder form.

In addition to the components defined and described above, the agents can contain further ingredients, for example at least one further constituent, preferably at least two further constituents, which further improve the practical and/or aesthetic properties of the agent. These include, for example, fragrances, surfactants, builders, as well as additives for adjusting the viscosity and/or for stabilization, as well as other auxiliary substances and additives commonly used in detergents, such as UV stabilizers, dyes, pearlescent agents, preservatives, bitter substances, organic salts, disinfectants, (structural) polymers, defoamers and pH adjusters.

In compositions according to the invention, the amount of correspondingly suitable constituents depends on the relevant intended use of the composition, and a trained person skilled in the art is generally familiar with suitable dosages of these constituents or is able to find correspondingly suitable quantity information in the literature.

In various embodiments, an agent as described herein further comprises at least one fragrance.

As fragrances, odorants or perfume oils, all substances and mixtures known for this purpose can be used. Within the meaning of this invention, the terms “odorant(s)”, “fragrances” and “perfume oil(s)” are used synonymously. The terms refer, in particular, to all substances or mixtures thereof which are perceived by humans and animals as having an odor, in particular perceived by humans as having a pleasant odor.

Perfumes, perfume oils, or perfume oil components may be used as fragrance components. Perfume oils or fragrances can, according to the invention, be individual odorant compounds, such as synthetic products of the ester, ether, aldehyde, ketone, alcohol, and hydrocarbon types.

Fragrance compounds of the aldehyde type are, for example, adoxal (2,6,10-trimethyl-9-undecenal), anisaldehyde (4-methoxybenzaldehyde), Cymal (3-(4-isopropyl-phenyl)-2-methylpropanal), ethylvanillin, Florhydral (3-(3-isopropylphenyl)butanal), helional (3-(3,4-methylenedioxyphenyl)-2-methylpropanal), heliotropin, hydroxycitronellal, lauraldehyde, Lyral (3- and 4-(4-hydroxy-4-methylpentyl)-3-cyclohexene-1-carboxaldehyde), methylnonylacetaldehyde, Lilial (3-(4-tert-butylphenyl)-2-methylpropanal), phenylacetaldehyde, undecylenealdehyde, vanillin, 2,6,10-trimethyl-9-undecenal, 3-dodecen-1-al, α-n-amylcinnamaldehyde, melonal (2,6-dimethyl-5-heptenal), 2,4-di-methyl-3-cyclohexene-1-carboxaldehyde (Triplal), 4-methoxybenzaldehyde, benzaldehyde, 3-(4-tert-butylphenyl)-propanal, 2-methyl-3-(para-methoxyphenyl)propanal, 2-methyl-4-(2,6,6-trimethyl-2(1)-cyclohexen-1-yl)butanal, 3-phenyl-2-propenal, cis-/trans-3,7-dimethyl-2,6-octadien-1-al, 3,7-dimethyl-6-octen-1-al, [(3,7-dimethyl-6-octenyl)oxy]acetaldehyde, 4-isopropylbenzylaldehyde, 1,2,3,4,5,6,7,8-octahydro-8,8-dimethyl-2-naphthaldehyde, 2,4-dimethyl-3-cyclohexene-1-carboxaldehyde, 2-methyl-3-(isopropylphenyl)propanal, 1-decanal, 2,6-dimethyl-5-heptenal, 4-(tricyclo[5.2.1.0(2,6)]-decylidene-8)-butanal, octahydro-4,7-methane-1H-indenecarboxaldehyde, 3-ethoxy-4-hydroxybenzaldehyde, para-ethyl-α,α-dimethylhydrocinnamaldehyde, α-methyl-3,4-(methylenedioxy)-hydrocinnamaldehyde, 3,4-methylenedioxybenzaldehyde, α-n-hexylcinnamaldehyde, m-cymene-7-carboxaldehyde, α-methylphenylacetaldehyde, 7-hydroxy-3,7-dimethyloctanal, undecenal, 2,4,6-trimethyl-3-cyclohexene-1-carboxaldehyde, 4-(3)(4-methyl-3-pentenyl)-3-cyclohexene carboxaldehyde, 1-dodecanal, 2,4-dimethylcyclohexene-3-carboxaldehyde, 4-(4-hydroxy-4-methylpentyl)-3-cyclohexene-1-carboxaldehyde, 7-methoxy-3,7-dimethyloctan-1-al, 2-methyl-undecanal, 2-methyldecanal, 1-nonanal, 1-octanal, 2,6,10-trimethyl-5,9-undecadienal, 2-methyl-3-(4-tert-butyl)propanal, dihydrocinnamaldehyde, 1-methyl-4-(4-methyl-3-pentenyl)-3-cyclohexene-1-carboxaldehyde, 5- or 6-methoxyhexahydro-4,7-methanindan-1- or -2-carboxaldehyde, 3,7-dimethyloctan-1-al, 1-undecanal, 10-undecen-1-al, 4-hydroxy-3-methoxybenzaldehyde, 1-methyl-3-(4-methylpentyl)-3-cyclohexenecarboxaldehyde, 7-hydroxy-3J-dimethyl-octanal, trans-4-decenal, 2,6-nonadienal, para-tolylacetaldehyde, 4-methylphenylacetaldehyde, 2-methyl-4-(2,6,6-trimethyl-1-cyclohexen-1-yl)-2-butenal, ortho-methoxycinnamaldehyde, 3,5,6-trimethyl-3-cyclohexene-carboxaldehyde, 3J-dimethyl-2-methylene-6-octenal, phenoxyacetaldehyde, 5,9-dimethyl-4,8-decadienal, peony aldehyde (6,10-dimethyl-3-oxa-5,9-undecadien-1-al), hexahydro-4,7-methanindan-1-carboxaldehyde, 2-methyloctanal, α-methyl-4-(1-methylethyl)benzeneacetaldehyde, 6,6-dimethyl-2-norpinene-2-propionaldehyde, para-methylphenoxyacetaldehyde, 2-methyl-3-phenyl-2-propen-1-al, 3,5,5-trimethylhexanal, hexahydro-8,8-dimethyl-2-naphthaldehyde, 3-propyl-bicyclo-[2.2.1]-hept-5-ene-2-carbaldehyde, 9-decenal, 3-methyl-5-phenyl-1-pentanal, methylnonylacetaldehyde, hexanal and trans-2-hexenal.

Fragrance compounds of the ketone type are, for example, methyl-β-naphthyl ketone, musk indanone (1,2,3,5,6,7-hexahydro-1,1,2,3,3-pentamethyl-4H-inden-4-one), tonalide (6-acetyl-1,1,2,4,4,7-hexamethyltetralin), α-damascone, β-damascone, δ-damascone, iso-damascone, damascenone, methyldihydrojasmonate, menthone, carvone, camphor, Koavone (3,4,5,6,6-pentamethylhept-3-en-2-one), fenchone, α-ionone, β-ionone, γ-methyl-ionone, fleuramone (2-heptylcyclopentanone), dihydrojasmone, cis-jasmone, Iso E Super (1-(1,2,3,4,5,6J,8-octahydro-2,3,8,8-tetramethyl-2-naphthalenyl)-ethan-1-one (and isomers)), methyl cedrenyl ketone, acetophenone, methyl acetophenone, para-methoxy acetophenone, methyl beta-naphthyl ketone, benzyl acetone, benzophenone, para-hydroxyphenyl butanone, celery ketone (3-methyl-5-propyl-2-cyclohexenone), 6-isopropyldecahydro-2-naphthone, dimethyloctenone, Freskomenthe (2-butan-2-yl-cyclohexan-1-one), 4-(1-ethoxyvinyl)-3,3,5,5-tetramethylcyclohexanone, methylheptenone, 2-(2-(4-methyl-3-cyclohexen-1-yl)propyl)cyclopentanone, 1-(p-menthen-6(2)-yl)-1-propanone, 4-(4-hydroxy-3-methoxyphenyl)-2-butanone, 2-acetyl-3,3-dimethylnorbornane, 6,7-dihydro-1,1,2,3,3-pentamethyl-4(5H)-indanone, 4-damascol, Dulcinyl (4-(1,3-benzodioxol-5-yl)butan-2-one), Hexalone (1-(2,6,6-trimethyl-2-cyclohexen-1-yl)-1,6-heptadien-3-one), Isocyclemone E (2-acetonaphthone-1,2,3,4,5,6,7,8-octahydro-2,3,8,8-tetramethyl), methyl nonylketone, methylcyclocitrone, methyl lavender ketone, Orivone (4-tert-amyl cyclohexanone), 4-tert-butyl cyclohexanone, Delphone (2-pentyl-cyclopentanone), muscone (CAS 541-91-3), Neobutenone (1-(5,5-dimethyl-1-cyclohexenyl) pent-4-en-1-one), plicatone (CAS 41724-19-0), Veloutone (2,2,5-trimethyl-5-pentylcyclopentan-1-one), 2,4,4,7-tetramethyl-oct-6-en-3-one and tetrameran (6,10-dimethylundecen-2-one).

Fragrance compounds of the alcohol type are, for example, 10-undecen-1-ol, 2,6-dimethylheptane-2-ol, 2-methylbutanol, 2-methylpentanol, 2-phenoxyethanol, 2-phenylpropanol, 2-tert-butylcyclohexanol, 3,5,5-trimethylcyclohexanol, 3-hexanol, 3-methyl-5-phenylpentanol, 3-octanol, 3-phenylpropanol, 4-heptenol, 4-isopropylcyclohexanol, 4-tert-butylcyclohexanol, 6,8-dimethyl-2-nonanol, 6-nonen-1-ol, 9-decen-1-ol, α-methylbenzyl alcohol, α-terpineol, amyl salicylate, benzyl alcohol, benzyl salicylate, β-terpineol, butyl salicylate, citronellol, cyclohexyl salicylate, decanol, dihydromyrcenol, dimethylbenzylcarbinol, dimethylheptanol, dimethyloctanol, ethyl salicylate, ethylvanillin, eugenol, geraniol, heptanol, hexyl salicylate, isoborneol, isoeugenol, isopulegol, linalool, menthol, myrtenol, n-hexanol, nerol, nonanol, octanol, para-menthan-7-ol, phenylethyl alcohol, phenol, phenyl salicylate, tetrahydrogeraniol, tetrahydrolinalool, thymol, trans-2-cis-6-nonadienol, trans-2-nonen-1-ol, trans-2-octenol, undecanol, vanillin, champiniol, hexenol and cinnamyl alcohol.

Fragrance compounds of the ester type are, for example, benzyl acetate, phenoxyethyl isobutyrate, p-tert-butylcyclohexyl acetate, linalyl acetate, dimethylbenzylcarbinyl acetate (DMBCA), phenylethyl acetate, benzyl acetate, ethylmethylphenyl glycinate, allylcyclohexyl propionate, styrallyl propionate, benzyl salicylate, cyclohexyl salicylate, floramate, melusate, and jasmacyclate.

The ethers include, for example, benzyl ethyl ether and Ambroxan. Hydrocarbons mainly include terpenes, such as limonene and pinene.

Preferably, mixtures of different fragrances are used, which together produce an attractive fragrance note. Such a mixture of fragrances can also be referred to as perfume or perfume oil. Perfume oils of this kind can also contain natural fragrance mixtures, as are obtained from plant sources.

Fragrances of plant origin include essential oils, such as angelica root oil, anise oil, arnica blossom oil, basil oil, bay oil, champaca blossom oil, citrus oil, noble fir oil, noble fir cone oil, elemi oil, eucalyptus oil, fennel oil, spruce needle oil, galbanum oil, geranium oil, ginger grass oil, guaiac wood oil, gurjun balsam oil, helichrysum oil, ho oil, ginger oil, iris oil, jasmine oil, cajeput oil, calamus oil, chamomile oil, camphor oil, cananga oil, cardamom oil, cassia oil, pine needle oil, copaiba balsam oil, coriander oil, spearmint oil, caraway seed oil, cumin oil, labdanum oil, lavender oil, lemongrass oil, lime blossom oil, lime oil, mandarin oil, melissa oil, mint oil, musk seed oil, muscatel oil, myrrh oil, clove oil, neroli oil, niaouli oil, olibanum oil, orange blossom oil, orange peel oil, origanum oil, palmarosa oil, patchouli oil, Peru balsam oil, petitgrain oil, pepper oil, peppermint oil, allspice oil, pine oil, rose oil, rosemary oil, sage oil, sandalwood oil, celery oil, spike oil, star anise oil, turpentine oil, thuja oil, thyme oil, verbena oil, vetiver oil, juniper berry oil, wormwood oil, wintergreen oil, ylang-ylang oil, hyssop oil, cinnamon oil, cinnamon leaf oil, citronella oil, lemon oil and cypress oil, as well as ambrettolide, ambroxan, α-amyl cinnamaldehyde, anethol, anisaldehyde, anisic alcohol, anisole, anthranilic acid methyl ester, acetophenone, benzylacetone, benzaldehyde, benzoic acid ethyl ester, benzophenone, benzyl alcohol, benzyl acetate, benzyl benzoate, benzyl formate, benzyl valerate, borneol, bornyl acetate, boisambrene forte, α-bromostyrene, n-decyl aldehyde, n-dodecyl aldehyde, eugenol, eugenol methyl ether, eucalyptol, farnesol, fenchone, fenchyl acetate, geranyl acetate, geranyl formate, heliotropin, heptincarboxylic acid methyl ester, heptaldehyde, hydroquinone dimethyl ether, hydroxycinnamaldehyde, hydroxycinnamic alcohol, indole, iran, isoeugenol, isoeugenol methyl ether, isosafrol, jasmone, camphor, carvacrol, carvone, p-cresol methyl ether, coumarin, p-methoxyacetophenone, methyl n-amyl ketone, methyl anthranilic acid methyl ester, p-methyl acetophenone, methyl chavicol, p-methyl quinoline, methyl-β-naphthyl ketone, methyl-n-nonyl acetaldehyde, methyl-n-nonyl ketone, muscone, β-naphthol ethyl ether, β-naphthol methyl ether, nerol, n-nonyl aldehyde, nonyl alcohol, n-octyl aldehyde, p-oxy acetophenone, pentadecanolide, β-phenylethyl alcohol, phenylacetic acid, pulegone, safrole, salicylic acid isoamyl ester, salicylic acid methyl ester, salicylic acid hexyl ester, salicylic acid cyclohexyl ester, santalol, sandelice, skatole, terpineol, thymene, thymol, troenan, γ-undelactone, vanillin, veratrum aldehyde, cinnamaldehyde, cinnamic alcohol, cinnamic acid, cinnamic acid ethyl ester, cinnamic acid benzyl ester, diphenyl oxide, limonene, linalool, linalyl acetate and propionate, melusate, menthol, menthone, methyl-n-heptenone, pinene, phenylacetaldehyde, terpinyl acetate, citral, citronellal, and mixtures thereof.

Mixtures of said substances may also be used.

If it is to be perceptible, an odorant has to be volatile, with the molar mass, in addition to the nature of the functional groups and the structure of the chemical compound, also playing an important role. Therefore, most odorants have molar masses of up to approximately 200 daltons, while molar masses of 300 daltons and above are something of an exception. Due to the differing volatility of odorants, the odor of a perfume or fragrant substance composed of multiple odorants varies over the course of vaporization, wherein the odor impressions are divided into “top note,” “middle note” or “body” and “end note” or “dry out”. Analogously to the description in the international patent publication WO 2016/200761, the top, middle and end notes can be classified on the basis of their vapor pressure (determinable by means of the test methods described in WO 2016/200761) as follows:
Top note: vapor pressure at 25° C.: >0.0133 kPa
Middle note: vapor pressure at 25° C.: 0.0133 to 0.000133 kPa
End note: vapor pressure at 25° C.: <0.000133 kPa

Examples of adherent odorants that can be used within the scope of the present invention are essential oils, such as angelica root oil, aniseed oil, arnica blossom oil, basil oil, bay oil, bergamot oil, champaca blossom oil, abies alba oil, abies alba cone oil, elemi oil, eucalyptus oil, fennel oil, spruce needle oil, galbanum oil, geranium oil, ginger grass oil, guaiac wood oil, gurjun balsam oil, helichrysum oil, ho oil, ginger oil, iris oil, cajeput oil, calamus oil, chamomile oil, camphor oil, cananga oil, cardamom oil, cassia oil, pine needle oil, copaiba balsam oil, coriander oil, spearmint oil, caraway oil, cumin oil, lavender oil, lemon grass oil, lime oil, mandarin oil, melissa oil, musk seed oil, myrrh oil, clove oil, neroli oil, niaouli oil, olibanum oil, orange oil, oregano oil, palmarosa oil, patchouli oil, Peru balsam oil, petitgrain oil, pepper oil, peppermint oil, allspice oil, pine oil, rose oil, rosemary oil, sandalwood oil, celery oil, spike lavender oil, star anise oil, turpentine oil, thuja oil, thyme oil, verbena oil, vetiver oil, juniper berry oil, wormwood oil, wintergreen oil, ylang-ylang oil, hyssop oil, cinnamon oil, cinnamon leaf oil, citronella oil, lemon oil, and cypress oil.

Higher boiling or solid odorants of natural or synthetic origin include, for example, ambrettolide, α-amyl cinnamaldehyde, anethol, anisaldehyde, anisyl alcohol, anisole, anthranilic acid methyl ester, acetophenone, benzyl acetone, benzaldehyde, benzoic acid ethyl ester, benzophenone, benzyl alcohol, benzyl acetate, benzyl benzoate, benzyl formate, benzyl valeriate, borneol, bornyl acetate, α-bromostyrene, n-decyl aldehyde, n-dodecyl aldehyde, eugenol, eugenol methyl ether, eucalyptol, farnesol, fenchone, fenchyl acetate, geranyl acetate, geranyl formate, heliotropin, heptyne carboxylic acid methyl ester, heptaldehyde, hydroquinone dimethyl ether, hydroxycinnamaldehyde, hydroxycinnamyl alcohol, indole, irone, isoeugenol, isoeugenol methyl ether, isosafrole, jasmone, camphor, carvacrol, carvone, p-cresol methyl ether, coumarin, p-methoxyacetophenone, methyl n-amyl ketone, methyl anthranilic acid methyl ester, p-methyl acetophenone, methyl chavicol, p-methyl quinoline, methyl β-naphthyl ketone, methyl n-nonyl acetaldehyde, methyl n-nonyl ketone, muscone, β-naphthol ethyl ether, β-naphthol methyl ether, nerol, nitrobenzene, n-nonyl aldehyde, nonyl alcohol, n-octyl aldehyde, p-oxyacetophenone, pentadecanolide, β-phenyl ethyl alcohol, phenyl acetaldehyde dimethyl acetal, phenylacetic acid, pulegone, safrole, salicylic acid isoamyl ester, salicylic acid methyl ester, salicylic acid hexyl ester, salicylic acid cyclohexyl ester, santalol, skatole, terpineol, thymene, thymol, γ-undecalactone, vanillin, veratrum aldehyde, cinnamaldehyde, cinnamyl alcohol, cinnamic acid, cinnamic acid ethyl ester, cinnamic acid benzyl ester.

More volatile odorants include in particular lower-boiling odorants of natural or synthetic origin, which may be used alone or in mixtures. Examples of more volatile odorants are alkyl isothiocyanates (alkyl mustard oils), butanedione, limonene, linalool, linayl acetate and propionate, menthol, menthone, methyl-n-heptenone, phellandrene, phenylacetaldehyde, terpinyl acetate, citral and citronellal.

Odorant compounds of the aldehyde type that can preferably be used are hydroxycitronellal (CAS 107-75-5), helional (CAS 1205-17-0), citral (5392-40-5), bourgeonal (18127-01-0), Triplal (CAS 27939-60-2), Ligustral (CAS 68039-48-5), Vertocitral (CAS 68039-49-6), Florhydral (CAS 125109-85-5), citronellal (CAS 106-23-0) and citronellyloxyacetaldehyde (CAS 7492-67-3).

In addition to or as an alternative to the above-mentioned odorants, it is also possible to use the odorants described in WO 2016/200761, in particular the odorants mentioned in tables 1, 2 and 3, and the modulators listed in tables 4a and 4b. The whole of this publication is incorporated herein by way of reference.

A perfume oil can also be present in the form of a perfume oil preparation and, for example, comprise at least one further active substance in oil form. Suitable active substances in oil form in this context are those which are suitable for washing, cleaning, care and/or finishing purposes, in particular
(a) textile care substances, such as preferably silicone oils, and/or
(b) skin care substances, such as preferably vitamin E, natural oils and/or cosmetic oils.

Skin care active substances are all those active substances which give the skin a sensory and/or cosmetic advantage. Skin care active substances are preferably selected from the following substances:
a) waxes, such as carnauba, spermaceti, beeswax, lanolin and/or derivatives thereof and others;
b) hydrophobic plant extracts;
c) hydrocarbons, such as squalene and/or squalane;
d) higher fatty acids, preferably those having at least 12 carbon atoms, e.g., lauric acid, stearic acid, behenic acid, myristic acid, palmitic acid, oleic acid, linoleic acid, linolenic acid, isostearic acid and/or polyunsaturated fatty acids and others;
e) higher fatty alcohols, preferably those having at least 12 carbon atoms, e.g., lauryl alcohol, cetyl alcohol, stearyl alcohol, oleyl alcohol, behenyl alcohol, cholesterol and/or 2-hexadecanol and others;
f) esters, preferably such as cetyloctanoate, lauryl lactate, myristyl lactate, cetyl lactate, isopropyl myristate, myristyl myristate, isopropyl palmitate, isopropyl adipate, butyl stearate, decyl oleate, cholesteryl isostearate, glycerol monostearate, glyceryl distearate, glycerol tristearate, alkyl lactate, alkyl citrate and/or alkyl tartrate and others;
g) lipids, such as cholesterol, ceramides and/or sucrose esters and others;
h) vitamins, such as vitamins A, C and E, vitamin alkyl esters, including vitamin C alkyl esters and others;
i) sunscreens;
j) phospholipids;
k) derivatives of α-hydroxy acids;
l) germicides for cosmetic use, both synthetic, such as salicylic acid, and/or others, and natural, such as neem oil and/or others;
m) silicones;
n) natural oils, e.g., almond oil;
and mixtures of any of the components listed above.

In various embodiments, the content of the at least one fragrance, which can also be present in the form of a perfume oil or as a component of a perfume oil composition, as described above, is preferably between approximately 0.0001 to 5 wt. %, in particular between approximately 0.005 and 3.0 wt. %, preferably between approximately 0.01 and 1.5 wt. %, even more preferably between approximately 0.05 and 1.0 wt. %, in each case based on the total weight of a particular agent.

It may be desirable to keep sensitive benefit agents/active ingredients, such as perfumes and fragrances, as described above, spatially separated from other constituents of the detergent until they are used. An elegant method for incorporating such sensitive, chemically or physically incompatible or volatile ingredients is the use of microcapsules, in which these ingredients are enclosed in a storage-stable and transport-stable manner and from which they are released mechanically, chemically, thermally or enzymatically for or during use.

In a preferred embodiment, a fragrance as defined above and possibly also other components, such as additional fragrances and active ingredients that improve the skin feel, are therefore incorporated in whole or in part into microcapsules.

“Microcapsule”, as used herein, refers to capsules having a core-shell morphology on a micrometer scale, comprising a capsule shell which completely encloses a core. “Completely encloses” or “completely surrounds”, as used herein with reference to the microcapsules, means that the core is completely surrounded by the shell, i.e., it is in particular not embedded in a matrix such that it is exposed at any point. It is also preferable for the capsule shell to be such that the release of the contents is controlled, i.e., the contents are not released in a spontaneous and uncontrolled manner, independently of any release stimulus. For this reason, the capsule shell is preferably substantially impermeable to the encapsulated contents. “Substantially impermeable”, as used in this context, means that the contents of the capsule or individual ingredients cannot spontaneously pass through the shell, but rather the contents can only be released by the capsule being opened or optionally by means of a diffusion process that takes place over a long period of time. The core may be solid, liquid and/or gaseous, but is preferably solid and/or liquid. The microcapsules are preferably substantially spherical and have a diameter in the range of from 0.01 to 1000 μm, in particular from 0.1 to 500 μm. The capsule shell and capsule core are made of different materials; in particular, under standard conditions (20° C., 1013 mbar), the capsule shell is preferably solid, and the core is preferably solid and/or liquid, in particular liquid.

High-molecular compounds of animal or vegetable origin, e.g., protein compounds (gelatin, albumin, casein), cellulose derivatives (methylcellulose, ethylcellulose, cellulose acetate, cellulose nitrate, carboxymethylcellulose) and in particular synthetic polymers (e.g., polyamides, polyolefins, polyesters, polyurethanes, epoxy resins, silicone resins and condensation products of carbonyl- and NH group-containing compounds), for example, can very generally be used as the capsule material for the microcapsules that are suitable in the context of the present invention. Specifically, the shell material can be selected, for example, from polyacrylates, polyethylene, polyamides, polystyrenes, polyisoprenes, polycarbonates, polyesters, polyureas, polyurethanes, polyolefins, polysaccharides, epoxy resins, vinyl polymers, urea crosslinked with formaldehyde or glutaraldehyde, melamine crosslinked with formaldehyde, gelatin-polyphosphate coacervates optionally crosslinked with glutaraldehyde, gelatin-gum arabic coacervates, silicone resins, polyamines reacted with polyisocyanates, acrylate monomers polymerized by means of free radical polymerization, silk, wool, gelatin, cellulose, proteins, and mixtures and copolymers thereof. Polyacrylates, polyethylene, polyamides, polystyrenes, polyisoprenes, polycarbonates, polyesters, polyureas, polyurethanes, polyolefins, epoxy resins, vinyl polymers and urea and/or melamine crosslinked with formaldehyde or glutaraldehyde are particularly preferred.

Methods which are suitable for producing suitable microcapsules are in principle those known microencapsulation methods in which, for example, the phase to be encapsulated is encapsulated by being coated with film-forming polymers (such as those mentioned above) which precipitate on the material to be covered after emulsification and coacervation or interfacial polymerization. With respect to the present invention, the phase to be encapsulated is a benefit agent composition, preferably a fragrance composition, usually in the form of a perfume oil.

The capsules can release the encapsulated benefit agents using various mechanisms. For example, in various embodiments of the present invention, capsules can be used which have a mechanically stable capsule shell which then becomes permeable to the agents contained therein due to one or more environmental influences, such as changes in the temperature or the ionic strength or the pH of the surrounding medium. Stable capsule wall materials through which the at least one benefit agent, e.g. a perfume oil, and optionally further benefit agents, can diffuse over time are also possible. The capsules may release the at least one contained benefit agent preferably when the pH or the ionic strength of the environment changes, when the temperature changes, upon exposure to light, by diffusion and/or under mechanical stress.

In a preferred embodiment of the present invention, the capsules are fragile, that is to say they can release the encapsulated agent due to mechanical stress, such as friction, pressure, or shear stress, which breaks the shell of the capsules. In another embodiment, the capsule is thermally labile, that is to say encapsulated substances may be released when the capsules are exposed to a temperature of at least 70° C., preferably at least 60° C., more preferably at least 50° C., and in particular at least 40° C.

In another preferred embodiment, the capsule for the encapsulated benefit agent(s) may become permeable after exposure to radiation of a certain wavelength, preferably by exposure to sunlight.

It is also possible that the capsules are fragile and at the same time thermally labile and/or unstable to radiation of a certain wavelength.

Suitable microcapsules can be water-soluble and/or water-insoluble, but are preferably water-insoluble capsules. The water-insolubility of the capsules has the advantage that they can withstand washing, cleaning or other treatment applications and can thus dispense the at least one benefit agent only after the aqueous washing, cleaning or treatment process, such as when drying due to a mere increase in temperature or due to sunlight or in particular with friction on the surface.

Water-insoluble capsules which are broken up by friction are particularly preferred.

The term “abradable” capsules or capsules that “can be broken up by friction” means in particular those capsules which, when they adhere to a surface treated therewith (e.g., a textile surface), can be opened or broken by mechanical friction or pressure, so that the contents are released only as a result of mechanical action, for example, if someone dries their hands on a towel on which such capsules are deposited.

Advantageously usable, abradable capsules can have average diameters d₅₀ of <250 μm, preferably in the range of from 1 to 100 μm, more preferably between 3 and 95 μm, in particular between 4 and 90 μm, for example between 5 and 80 μm, e.g. between 5 and 40 μm. The d₅₀ value indicates the diameter which results when 50 wt. % of the capsules have a smaller diameter and 50 wt. % of the capsules have a larger diameter than the stated d₅₀ value. It is furthermore preferred for the doo value of the particle size distribution of the microcapsules to be <70 μm, preferably <60 μm, particularly preferably <50 m. The doo value of the particle size distribution is the value at which 90% of all particles are smaller and 10% of the particles are larger than this value.

The shell of the capsules enclosing the core or (filled) cavity preferably has an average thickness in the range between approximately 50 and 500 nm, preferably between approximately 100 nm and approximately 250 nm. Capsules are particularly abradable if they are within the ranges given above for the average diameter and the average thickness.

The d₅₀ value indicates the diameter which results when 50 wt. % of the capsules have a smaller diameter and 50 wt. % of the capsules have a larger diameter than the stated d₅₀ value. It is furthermore preferred for the doo value of the particle size distribution of the microcapsules to be <70 μm, preferably <60 μm, particularly preferably <50 μm. The d₉₀ value of the particle size distribution is the value at which 90% of all particles are smaller and 10% of the particles are larger than this value.

The diameter of the capsules or the particle size of the microcapsules can be determined by conventional methods. It can be determined, for example, by means of dynamic light scattering, which can usually be carried out on dilute suspensions containing, for example, 0.01 to 1 wt. % of capsules. It can also be determined by evaluating light microscopic or electron microscopic images of capsules.

In various embodiments, a microcapsule according to the invention has an average diameter d₅₀ of from approximately 1 to 80 μm, preferably approximately 5 to 40 μm, in particular approximately 20 to 35 μm, e.g., approximately 22 to approximately 33 μm.

The wall material of the microcapsules preferably comprises polyurethanes, polyolefins, polyamides, polyesters, polysaccharides, epoxy resins, silicone resins and/or polycondensation products of carbonyl compounds and NH group-containing compounds. This corresponds to a preferred embodiment of the invention. Melamine-urea-formaldehyde microcapsules or melamine-formaldehyde microcapsules or urea-formaldehyde microcapsules can be preferably used, for example. Particularly preferred are microcapsules based on melamine-formaldehyde resins.

The general approach to producing microcapsules as such has long been known to a person skilled in the art. Particularly suitable methods for producing microcapsules are described in principle in U.S. Pat. Nos. 3,516,941, 3,415,758 or EP 0026914 A1, for example. The document mentioned last describes, for example, producing microcapsules by acid-induced condensation of melamine-formaldehyde precondensates and/or the C₁-C₄ alkyl ethers thereof in water, in which the hydrophobic material forming the capsule core is dispersed, in the presence of a protective colloid.

In various embodiments, an agent as described herein comprises in particular at least one surfactant. Suitable surfactants are, in particular, anionic surfactants, non-ionic surfactants and mixtures thereof, but also cationic, zwitterionic and amphoteric surfactants.

Suitable compounds from the class of anionic surfactants are those of formula (V)

R—SO₃⁻X⁺ (V),
where R represents a linear or branched unsubstituted alkylaryl functional group, and X represents a monovalent cation or the nth part of an n-valent cation, in this case the alkali metal ions are preferred, and of those Na⁺ or K⁺, wherein Na⁺ is most preferred. Further cations X⁺ may be selected from NH₄⁺, ½ Zn²⁺, ½ Mg²⁺, ½ Ca²⁺, ½ Mn²⁺, and the mixtures thereof.

“Alkylaryl”, as used herein, refers to organic functional groups that consist of an alkyl functional group and an aromatic functional group. Typical examples of functional groups of this kind include, but are not restricted to, alkylbenzene functional groups, such as benzyl, butylbenzene functional groups, nonylbenzene functional groups, decylbenzene functional groups, undecylbenzene functional groups, dodecylbenzene functional groups, tridecylbenzene functional groups and the like.

In various embodiments, surfactants of this kind are selected from linear or branched alkylbenzene sulfonates of formula (V-1):

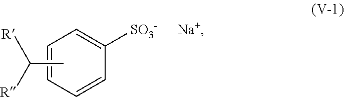

in which R′ and R″ together contain 9 to 19, preferably 11 to 15, and in particular 11 to 13, C atoms. A very particularly preferred representative can be described by formula A-1a:

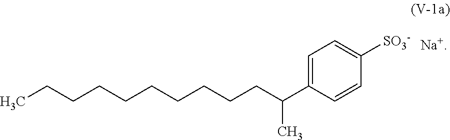

In various embodiments, the compound of formula (V) is preferably the sodium salt of a linear alkylbenzene sulfonate.

Preferred anionic surfactants are those of formula (VI)

R¹—O—(AO)ₙ—SO₃⁻X⁺ (VI)

In formula (VI), R¹ represents a linear or branched, substituted or unsubstituted alkyl functional group, preferably a linear, unsubstituted alkyl functional group, particularly preferably a fatty alcohol functional group. Preferred functional groups R¹ are selected from decyl, undecyl, dodecyl, tridecyl, tetradecyl, pentadecyl, hexadecyl, heptadecyl, octadecyl, nonadecyl and eicosyl functional groups and mixtures thereof, wherein the representatives having an even number of C atoms are preferred. Particularly preferred functional groups R¹ are derived from C₁₂₋₁₈ fatty alcohols, for example from coconut fatty alcohol, tallow fatty alcohol, lauryl, myristyl, cetyl or stearyl alcohol or from C₁₀₋₂₀ oxo alcohols. X represents a monovalent cation or the nth part of an n-valent cation, the alkali metal ions being preferred, and of those Na⁺ or K⁺, wherein Na⁺ is most preferred. Further cations X⁺ may be selected from NH₄⁺, ½ Zn²⁺, ½ Mg²⁺, ½ Ca²⁺, ½ Mn²⁺, and the mixtures thereof. AO represents an ethylene oxide (EO) group or propylene oxide (PO) group, preferably an ethylene oxide group. The index n represents an integer from 1 to 50, preferably from 1 to 20, and in particular from 2 to 10. Very particularly preferably, n represents the numbers 2, 3, 4, 5, 6, 7 or 8. X represents a monovalent cation or the nth part of an n-valent cation, the alkali metal ions being preferred, and of those Na⁺ or K⁺, wherein Na⁺ is most preferred. Further cations X+ can be selected from NH₄⁺, ½ Zn²⁺, ½ Mg²⁺, ½ Ca²⁺, ½ Mn²⁺ and the mixtures thereof.

In summary, agents in various embodiments can thus contain at least one anionic surfactant selected from fatty alcohol ether sulfates of formula (VI-1)

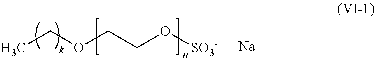

where k=11 to 19, and n=2, 3, 4, 5, 6, 7 or 8. Particularly preferred representatives are Na—C₁₂₋₁₄ fatty alcohol ether sulfates having 2 EO (k=11-13, n=2 in formula (VI-1)).

Other anionic surfactants that can preferably be used are the alkyl sulfates of formula (VII)

R²—O—SO₃⁻X⁺ (VII).

In formula (VII), R² represents a linear or branched, substituted or unsubstituted alkyl functional group, preferably a linear, unsubstituted alkyl functional group, particularly preferably a fatty alcohol functional group. Preferred functional groups R² are selected from decyl, undecyl, dodecyl, tridecyl, tetradecyl, pentadecyl, hexadecyl, heptadecyl, octadecyl, nonadecyl and eicosyl functional groups and mixtures thereof, wherein the representatives having an even number of C atoms are preferred. Particularly preferred functional groups R² are derived from C₁₂₋₁₈ fatty alcohols, for example from coconut fatty alcohol, tallow fatty alcohol, lauryl, myristyl, cetyl or stearyl alcohol or from C₁₀₋₂₀ oxo alcohols. X represents a monovalent cation or the nth part of an n-valent cation, the alkali metal ions being preferred, and of those Na⁺ or K⁺, wherein Na⁺ is most preferred. Further cations X⁺ may be selected from NH₄⁺, ½ Zn²⁺, ½ Mg²⁺, ½ Ca²⁺, ½ Mn²⁺, and the mixtures thereof.

In various embodiments, these surfactants are selected from fatty alcohol sulfates of formula (VII-1)

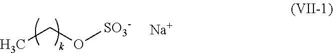

where k=11 to 19. Very particularly preferred representatives are Na—C₁₂₋₁₄ fatty alcohol sulfates (k=11-13 in formula (VII-1)).

Other anionic surfactants that can be used are the alkyl ester sulfonates, in particular those of formula (VIII)

R¹—CH(SO₃⁻X⁺)—C(O)—O—R² (VIII).

In formula (VIII), R¹ represents a linear or branched, substituted or unsubstituted alkyl functional group, preferably a linear, unsubstituted alkyl functional group. Preferred functional groups R¹ are selected from nonyl, decyl, undecyl, dodecyl, tridecyl, tetradecyl, pentadecyl, hexadecyl, heptadecyl, octadecyl, nonadecyl, eicosyl, heneicosyl functional groups and mixtures thereof, the representatives having an odd number of C atoms being preferred. Particularly preferred functional groups R¹—CH are derived from C₁₂₋₁₈ fatty acids, for example from lauryl, myristyl, cetyl or stearyl acid. R² represents a linear or branched, substituted or unsubstituted alkyl functional group, preferably a linear, unsubstituted alkyl functional group. Preferred functional groups R² are C₁₋₆ alkyl functional groups, in particular methyl (=methyl ester sulfonates). X represents a monovalent cation or the nth part of an n-valent cation, the alkali metal ions being preferred, and of those Na⁺ or K⁺, wherein Na⁺ is most preferred. Further cations X⁺ may be selected from NH₄⁺, ½ Zn²⁺, ½ Mg²⁺, ½ Ca²⁺, ½ Mn²⁺, and the mixtures thereof.

The secondary alkane sulfonates are also suitable as anionic surfactants. These have, for example, formula (IX)

R¹CH(SO₃⁻X⁺)R² (IX)
where R¹ and R² are each independently a linear or branched alkyl having 1 to 20 carbon atoms and form with the carbon atom to which they are bonded a linear or branched alkyl, preferably having 10 to 30 carbon atoms, more preferably having 10 to 20 carbon atoms, and X⁺ is selected from the group Na⁺, K⁺, NH₄⁺, ½ Zn²⁺, ½ Mg²⁺, ½ Ca²⁺, ½ Mn²⁺ and mixtures thereof, preferably Na⁺.

In various preferred embodiments, the at least one secondary alkane sulfonate has the following formula (IX-1)

H₃C—(CH₂)ₙ—CH(SO₃⁻X⁺)—(CH₂)ₘ—CH₃ (IX-1)
where m and n are each, independently of one another, an integer between 0 and 20. Preferably, m+n is an integer between 7 and 17, preferably 10 to 14, and X⁺ is selected from the group Na⁺, K⁺, NH₄⁺, ½ Zn²⁺, ½ Mg²⁺, ½ Ca²⁺, ½ Mn²⁺ and mixtures thereof, preferably Na⁺.

In a particularly preferred embodiment, the at least one secondary alkane sulfonate is secondary C₁₄₋₁₇ sodium alkane sulfonate. A secondary C₁₄₋₁₇ sodium alkane sulfonate of this kind is marketed, for example, by Clariant under the trade name “Hostapur SAS60.”

Fatty alcohol alkoxylates in particular are suitable as non-ionic surfactants. In different embodiments, the agents therefore contain at least one non-ionic surfactant of formula (X)

R³—O—(AO)ₘ—H (X).

In formula (X), R³ represents a linear or branched, substituted or unsubstituted alkyl functional group, preferably a linear, unsubstituted alkyl functional group, particularly preferably a fatty alcohol functional group. Preferred functional groups R² are selected from decyl, undecyl, dodecyl, tridecyl, tetradecyl, pentadecyl, hexadecyl, heptadecyl, octadecyl, nonadecyl and eicosyl functional groups and mixtures thereof, wherein the representatives having an even number of C atoms are preferred. Particularly preferred functional groups R³ are derived from C₁₂₋₁₈ fatty alcohols, for example from coconut fatty alcohol, tallow fatty alcohol, lauryl, myristyl, cetyl or stearyl alcohol or from C₁₀₋₂₀ oxo alcohols. AO represents an ethylene oxide (EO) group or propylene oxide (PO) group, preferably an ethylene oxide group. The index m represents an integer from 1 to 50, preferably from 1 to 20, and in particular from 2 to 10. Very particularly preferably, m represents the numbers 2, 3, 4, 5, 6, 7 or 8.

In summary, the fatty alcohol alkoxylates to be preferably used are compounds of formula (X-1)

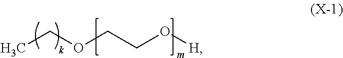

where k=11 to 19, and m=2, 3, 4, 5, 6, 7 or 8. Very particularly preferred representatives are C₁₂₋₁₈ fatty alcohols having 7 EO (k=11-17, m=7 in formula (X-1)).

Amine oxides, for example, are also suitable as non-ionic surfactants. In principle, all the amine oxides established in the prior art for this purpose, i.e., compounds that have the formula R¹R²R³NO, where each of R¹, R² and R³, independently of the others, is an optionally substituted, e.g., hydroxy-substituted, C₁₋₃₀ hydrocarbon chain, can be used in this respect. Amine oxides that are particularly preferably used are those in which R¹ is C₁₂₋₁₈ alkyl, and R² and R³ are, independently, each C₁₋₄ alkyl, in particular C₁₂₋₁₈ alkyl dimethyl amine oxides. Examples of representatives of suitable amine oxides are N-coconut-alkyl-N, N-dimethyl amine oxide, N-tallow alkyl-N,N-dihydroxyethyl amine oxide, myristyl/cetyl dimethyl amine oxide or lauryl dimethyl amine oxide.

Other non-ionic surfactants that can be present in the described agents within the meaning of the present invention include, but are not limited to, alkyl glycosides, alkoxylated fatty acid alkyl esters, fatty acid alkanolamides, hydroxy mixed ethers, sorbitan fatty acid esters, polyhydroxy fatty acid amides and alkoxylated alcohols. Such surfactants are known in the prior art.

Suitable alkyl(poly)glycosides are, for example, those of the formula R²O—[G]ₚ, in which R² is an unbranched or branched alkyl having 12 to 16 carbon atoms, G is a sugar functional group having 5 or 6 carbon atoms, in particular glucose, and the index p is 1 to 10.

Suitable amphoteric surfactants are, for example, betaines of formula (XI)

(Rⁱⁱⁱ)(R^{iv})(R^{v})N⁺CH₂COO⁻ (XI),
in which Rⁱⁱⁱ denotes an alkyl group, which is optionally interrupted by heteroatoms or heteroatom groups, having 8 to 25, preferably 10 to 21, carbon atoms, and R^{iv} and R^{v} denote identical or different alkyl functional groups having 1 to 3 carbon atoms, in particular C₁₀₋₁₈ alkyl dimethyl carboxymethyl betaine and C₁₁₋₁₇ alkyl amidopropyl dimethyl carboxymethyl betaine.

Suitable cationic surfactants include among others the quaternary ammonium compounds of formula (XII)

(R^{vi})(R^{vii})(R^{viii})(R^{ix})N⁺X⁻ (XII),
in which R^{vi} to R^{ix} represent four identical or different, in particular two long-chain and two short-chain, alkyl functional groups, and X⁻ represents an anion, in particular a halide ion, e.g., didecyldimethylammonium chloride, alkylbenzyldidecylammonium chloride, and mixtures thereof. Further suitable cationic surfactants are the quaternary surface-active compounds, in particular having a sulfonium, phosphonium, iodonium or arsonium group, which are also known as antimicrobial active ingredients. By using quaternary surface-active compounds having an antimicrobial effect, the agent can be provided with an antimicrobial effect or the antimicrobial effect that may already be present due to other ingredients can be improved.

In various embodiments, the total amount of surfactants, based on the total weight of the agent, is 5 to 75 wt. %, preferably 5 to 35 wt. %, even more preferably 10 to 30 wt. %.

An agent as described herein contains, in some embodiments, at least one water-soluble and/or water-insoluble, organic and/or inorganic builder.

The builders that can generally be used include, in particular, the aminocarboxylic acids and their salts, zeolites, silicates, carbonates, organic (co) builders and—where there are no ecological prejudices against their use—also the phosphates. However, according to preferred embodiments, the agents are phosphate-free.

For example, crystalline layered silicates of the general formula NaMSiₓO₂ₓ₊₁·y H₂O can be used, where M represents sodium or hydrogen, x is a number from 1.9 to 22, preferably from 1.9 to 4, wherein 2, 3, or 4 are particularly preferred values for x, and y represents a number from 0 to 33, preferably from 0 to 20. The crystalline layered silicates of the formula NaMSiₓO₂ₓ₊₁·y H₂O are sold, for example, by Clariant GmbH (Germany) under the trade name Na-SKS. Examples of these silicates are Na-SKS-1 (Na₂Si₂₂O₄₅·x H₂O, kenyaite), Na-SKS-2 (Na₂Si₁₄O₂₉·x H₂O, magadiite), Na-SKS-3 (Na₂Si₈O₁₇·x H₂O) or Na-SKS-4 (Na₂Si₄O₉·x H₂O, macatite). For the purposes of the present invention, crystalline sheet silicates of the formula NaMSiₓO₂ₓ₊₁·y H₂O, in which x is 2, are particularly suitable. In particular, both β- and δ-sodium disilicates Na₂Si₂O₅·y H₂O and, above all, Na-SKS-5 (α-Na₂Si₂O₅), Na-SKS-7 (β-Na₂Si₂O₅, natrosilite), Na-SKS-9 (NaHSi₂O₅·H₂O), Na-SKS-10 (NaHSi₂O₅·3 H₂O, kanemite), Na-SKS-11 (t-Na₂Si₂O₅) and Na-SKS-13 (NaHSi₂O₅), but in particular Na-SKS-6(δ-Na₂Si₂O₅) are preferred.

Amorphous sodium silicates with an Na₂O:SiO₂ modulus of from 1:2 to 1:3.3, preferably from 1:2 to 1:2.8 and in particular from 1:2 to 1:2.6, can also be used which preferably have retarded dissolution and secondary washing properties. The retarded dissolution compared to conventional amorphous sodium silicates can have been caused in a variety of ways, for example by way of surface treatment, compounding, compacting/compression or over-drying. Within the scope of this invention, the term “amorphous” is understood to mean that the silicates do not supply any sharp X-ray reflexes in X-ray diffraction experiments, such as those that are typical of crystalline substances, but at best cause one or more maxima of the scattered X-rays, which have a width of several degree units of the diffraction angle.

In the context of the present invention, it is preferred that this/these silicate(s), preferably alkali metal silicates, particularly preferably crystalline or amorphous alkali metal disilicates, are present in the agents in amounts of 1 to 40 wt. %, preferably from 2 to 35 wt. %, in each case based on the weight of the agent.

The agents can in particular also contain phosphonates as a further builder. A hydroxy alkane and/or amino alkane phosphonate is preferably used as a phosphonate compound. Among the hydroxyalkane phosphonates, 1-hydroxyethane-1,1-diphosphonate (HEDP) is of particular importance. Possible amino alkane phosphonates preferably include ethylenediamine tetramethylene phosphonate (EDTMP), diethylenetriamine pentamethylene phosphonate (DTPMP) and the higher homologs thereof. Phosphonates are preferably contained in the agents in amounts of from 0.1 to 10 wt. %, in particular in amounts of from 0.5 to 8 wt. %, in each case based on the total weight of the dishwashing detergent.

Other builders are the alkali carriers. Alkali carriers include, for example, alkali metal hydroxides, alkali metal carbonates, alkali metal hydrogen carbonates, alkali metal sesquicarbonates, the aforementioned alkali silicates, alkali metasilicates, and mixtures of the aforementioned substances, wherein in the context of this invention the alkali carbonates, in particular sodium carbonate, sodium hydrogen carbonate or sodium sesquicarbonate, can preferably be used. Due to their low chemical compatibility with some other ingredients of detergents compared to other builder substances, the optional alkali metal hydroxides are preferably only used in small amounts, preferably in amounts below 10 wt. %, preferably below 6 wt. %, particularly preferably below 4 wt. % and in particular below 2 wt. %, based in each case on the total weight of the agent. Agents which, based on the total weight thereof, contain less than 0.5 wt. % and in particular no alkali metal hydroxides are particularly preferred.

It is particularly preferred to use carbonate(s) and/or hydrogen carbonate(s), preferably alkali carbonate(s), particularly preferably sodium carbonate, in amounts of from 2 to 50 wt. %, preferably from 5 to 40 wt. %, and in particular from 7.5 to 30 wt. %, in each case based on the weight of the agent. Agents that, based on the weight of the agent, contain less than 20 wt. %, preferably less than 17 wt. %, preferably less than 13 wt. % and in particular less than 9 wt. % carbonate(s) and/or hydrogen carbonate(s), preferably alkali metal carbonate(s), particularly preferably sodium carbonate, are particularly preferred.

Organic builders that can be mentioned are in particular polycarboxylates/polycarboxylic acids, polymeric polycarboxylates, aspartic acid, polyacetals, dextrins, other organic cobuilders, as well as the phosphonates already mentioned above as builders. These substance classes are described below.

Suitable organic builder substances are, for example, the polycarboxylic acids that can be used in the form of the free acids and/or the sodium salts thereof, where polycarboxylic acids are understood to mean the carboxylic acids which carry more than one acid function. These include, for example, citric acid, adipic acid, succinic acid, glutaric acid, malic acid, tartaric acid, maleic acid, fumaric acid, saccharic acids, nitrilotriacetic acid (NTA), provided that the use thereof is not objectionable for ecological reasons, and mixtures thereof. In addition to their builder effect, the free acids typically also have the property of being an acidification component and are thus also used for setting a lower and milder pH. Particularly noteworthy here are citric acid, succinic acid, glutaric acid, adipic acid, gluconic acid, and any mixtures thereof.

Another important class of phosphate-free builders are aminocarboxylic acids and/or the salts thereof. Particularly preferred representatives of this class are methylglycinediacetic acid (MGDA) or the salts thereof, and glutamic diacetic acid (GLDA) or the salts thereof or ethylenediaminediacetic acid or the salts thereof (EDDS). Iminodisuccinic acid (IDS) and iminodiacetic acid (IDA) are also suitable. The content of these aminocarboxylic acids or the salts thereof can be, for example, between 0.1 and 30 wt. %, preferably between 1 and 25 wt. % and in particular between 5 and 20 wt. %. Aminocarboxylic acids and the salts thereof can be used together with the aforementioned builders.

In various embodiments, the at least one builder is selected from the group consisting of methylglycinediacetic acid (MGDA), glutaminediacetic acid (GLDA) and 1-hydroxyethane-1,1-diphosphonate (HEDP). MGDA is preferably used as MGDA trisodium salt (MGDA-Na₃), and GLDA is preferably used as GLDA tetrasodium salt (GLDA-Na₄).

In some embodiments, agents according to the invention or individual components of an agent according to the invention can contain water as the main solvent, i.e., it is an aqueous agent or an aqueous component. The water content of an aqueous agent or aqueous composition is usually 15 to 70 wt. %, preferably 20 to 60 wt. %. In various embodiments, the water content is more than 5 wt. %, preferably more than 15 wt. % and particularly preferably more than 50 wt. %, in each case based on the total amount of the aqueous agent or the aqueous component.

In addition, non-aqueous solvents can be added. Suitable non-aqueous solvents include monovalent or polyvalent alcohols, alkanol amines or glycol ethers, if they can be mixed with water in the stated concentration range. Preferably, the solvents are selected from ethanol, n-propanol, i-propanol, butanols, glycol, propanediol, butanediol, methylpropanediol, glycerol, diglycol, propyl diglycol, butyl diglycol, hexylene glycol, ethylene glycol methyl ether, ethylene glycol ethyl ether, ethylene glycol propyl ether, ethylene glycol mono-n-butyl ether, diethylene glycol methyl ether, diethylene glycol ethyl ether, propylene glycol methyl ether, propylene glycol ethyl ether, propylene glycol propyl ether, dipropylene glycol mono methyl ether, dipropylene glycol mono ethyl ether, methoxytriglycol, ethoxytriglycol, butoxytriglycol, 1-butoxyethoxy-2-propanol, 3-methyl-3-methoxybutanol, propylene-glycol-t-butylether, di-n-octylether, and mixtures of these solvents.

The one or more non-aqueous solvents is/are usually present in an amount of 0.1 to 60 wt. %, preferably 5 to 60 wt. %, more preferably 10 to 30 wt. %, based on the total weight of the aqueous agent or the aqueous component.

In general, the pH of the agents according to the invention can be adjusted using standard pH regulators. In various embodiments, the pH of the agents according to the invention is in a range from 6.5 to 12, preferably from 7.0 to 11.5, preferably greater than 7, in particular from 7.5 to 10.5. Acids and/or alkalis, preferably alkalis, are used as pH adjusters. Suitable acids are, in particular, organic acids, such as acetic acid, citric acid, glycolic acid, lactic acid, succinic acid, adipic acid, malic acid, tartaric acid and gluconic acid, or sulfamic acid. In addition, however, the mineral acids hydrochloric acid, sulfuric acid and nitric acid or mixtures thereof can also be used. Suitable bases originate from the group of alkali and alkaline-earth metal hydroxides and carbonates, in particular alkali metal hydroxides, of which potassium hydroxide is preferred. The alkali source described above is particularly preferably used to adjust the pH. Even if volatile alkali, for example in the form of ammonia and/or alkanolamines, which can contain up to 9 carbon atoms in the molecule, can be used to adjust the pH, it being possible for the alkanolamine to be selected from the group consisting of mono-, di-, triethanol- and -propanolamine and mixtures thereof, volatile alkali sources of this kind, in particular ethanolamines, are preferably avoided. In various embodiments, the agents according to the invention therefore contain less than 1.75 wt. % alkanolamine, in particular monoethanolamine, and are very particularly preferably free of same.

In order to adjust and/or stabilize the pH, an agent according to the invention can also contain one or more buffer substances (INCI buffering agents), usually in amounts from 0.001 to 5 wt. %. Buffer substances, which are also complexing agents or even chelating agents (chelators, INCI chelating agents), are preferred. Particularly preferred buffer substances are citric acid or citrates, in particular sodium citrates and potassium citrates, e.g. trisodium citrate·2 H₂O and tripotassium citrate·H₂O.

Polymers that are suitable as additives are in particular maleic acid-acrylic acid copolymer Na salt (e.g., commercially available Sokalan® CP 5 from BASF, Ludwigshafen (Germany)), modified polyacrylic acid Na salt (e.g., commercially available Sokalan® CP 10 from BASF, Ludwigshafen (Germany)), modified polycarboxylate Na salt (e.g., commercially available Sokalan® HP 25 from BASF, Ludwigshafen (Germany)), polyalkylene oxide, modified heptamethyltrisiloxane (e.g., commercially available Silwet® L-77 from BASF, Ludwigshafen (Germany)), polyalkylene oxide, modified heptamethyltrisiloxane (e.g., commercially available Silwet® L-7608 from BASF, Ludwigshafen (Germany)), as well as polyether siloxanes (copolymers of polymethyl siloxanes with ethylene oxide/propylene oxide segments (polyether blocks)), preferably water-soluble, linear polyether siloxanes with terminal polyether blocks, such as the commercially available compounds Tegopren® 5840, Tegopren® 5843, Tegopren® 5847, Tegopren® 5851, Tegopren® 5863, or Tegopren® 5878 from Evonik, Essen (Germany). In a particular embodiment of the invention, the above-mentioned polymers are omitted.

Polymeric thickening agents that can also be present in the agents are the polycarboxylates that have a thickening action as polyelectrolytes, preferably homo- and copolymerizates of acrylic acid, in particular acrylic acid copolymers, such as acrylic acid-methacrylic acid copolymers, and the polysaccharides, in particular heteropolysaccharides, and other conventional thickening polymers.

Suitable polysaccharides or heteropolysaccharides are the polysaccharide gums, e.g., gum arabic, agar, alginates, carrageenans and the salts thereof, guar, guar gum, tragacanth, gellan, ramsan, dextran or xanthan and the derivatives thereof, e.g., propoxylated guar, and mixtures thereof. Other polysaccharide thickeners, such as starches or cellulose derivatives, can be used alternatively, but preferably in addition, to a polysaccharide gum, e.g., starches of various origins and starch derivatives, e.g., hydroxyethyl starch, starch phosphate esters or starch acetates, or carboxymethyl cellulose or the sodium salt thereof, methyl, ethyl, hydroxyethyl, hydroxypropyl, hydroxypropyl methyl or hydroxyethyl methyl cellulose or cellulose acetate.

A preferred polymeric thickener is the microbial anionic heteropolysaccharide xanthan gum, which is produced by Xanthomonas campestris and some other species under aerobic conditions with a molecular weight of 2 to 15×10⁶ and is available, for example, from Kelco under the trade name Keltrol®, for example as a cream-colored powder Keltrol® T (Transparent) or as white granules Keltrol® RD (Readily Dispersable).

Acrylic acid polymers suitable as polymeric thickening agents are, for example, high-molecular-weight homopolymers of acrylic acid (INCI: carbomer) that are crosslinked with a polyalkenyl polyether, in particular an allyl ether of sucrose, pentaerythritol or propylene, and are also referred to as carboxyvinyl polymers. Such polyacrylic acids are available, inter alia, from BFGoodrich under the trade name Carbopol®, e.g. Carbopol® 940 (molecular weight Mw approx. 4,000,000 g/mol), Carbopol® 941 (molecular weight Mw approx. 1,250,000 g/mol) or Carbopol® 934 (molecular weight Mw approx. 3,000,000 g/mol).

However, particularly suitable polymeric thickeners are the following acrylic acid copolymers:
(i) copolymers of two or more monomers from the group of acrylic acid, methacrylic acid and the simple esters thereof, preferably formed with C₁₋₄ alkanols (INCI: Acrylates Copolymer), which include for instance the copolymers of methacrylic acid, butyl acrylate and methyl methacrylate (CAS 25035-69-2) or of butyl acrylate and methyl methacrylate (CAS 25852-37-3) and which are available, for example. from Rohm & Haas under the trade names Aculyn® and Acusol®, for example, the anionic non-associative polymers Aculyn® 33 (crosslinked), Acusol® 810 and Acusol® 830 (CAS 25852-37-3);
(ii) crosslinked high-molecular-weight acrylic acid copolymers, which include for instance the copolymers of C₁₀₋₃₀ alkyl acrylates crosslinked with an allyl ether of sucrose or pentaerythritol with one or more monomers from the group of acrylic acid, methacrylic acid and the simple esters thereof, preferably formed with C₁₋₄ alkanols (INCI Acrylates/C₁₀₋₃₀ Alkyl Acrylate Crosspolymer) and which are available, for example, from BFGoodrich under the trade name Carbopol®, e.g. the hydrophobized Carbopol® ETD2623 and Carbopol® 1382 (INCI: Acrylates/C₁₀₋₃₀ Alkyl Acrylate Crosspolymer) and Carbopol® AQUA 30 (formerly Carbopol® EX 473).

An agent as described herein can contain one or more water-soluble salts to reduce viscosity. These can be inorganic and/or organic salts; in a preferred embodiment, the agent contains at least one inorganic salt.

Inorganic salts which can be used according to the invention are preferably selected from the group comprising colorless water-soluble halides, sulfates, sulfites, carbonates, hydrogen carbonates, nitrates, nitrites, phosphates and/or oxides of alkali metals, alkaline earth metals, aluminum and/or transition metals; ammonium salts can also be used. Halides and sulfates of the alkali metals are particularly preferred; the inorganic salt is therefore preferably selected from the group comprising sodium chloride, potassium chloride, sodium sulfate, potassium sulfate and mixtures thereof. Sodium chloride is particularly preferred.

The organic salts that can be used according to the invention are, in particular, colorless water-soluble alkali metal, alkaline earth metal, ammonium, aluminum and/or transition metal salts of carboxylic acids, including dicarboxylic acids. The salts are preferably selected from the group comprising formate, acetate, propionate, citrate, malate, maleate, tartrate, succinate, malonate, oxalate, lactate, fumarate, adipate, succinate, glutarate, methylglycinediacetic acid trisodium salt, and mixtures thereof.

An optical brightener is preferably selected from the substance classes of distyrylbiphenyls, stilbenes, 4,4′-diamino-2,2′-stilbene disulfonic acids, cumarines, dihydroquinolones, 1,3-diarylpyrazolines, naphthalic acid imides, benzoxazole systems, benzisoxazole systems, benzimidazole systems, pyrene derivatives substituted with heterocycles, and mixtures thereof.

Particularly preferred suitable optical brighteners include disodium-4,4′-bis-(2-morpholino-4-anilino-s-triazine-6-ylamino) stilbene disulfonate (e.g., available as Tinopal® DMS from BASF SE), disodium-2,2′-bis-(phenyl-styryl)disulfonate (e.g., available as Tinopal® CBS from BASF SE), 4,4′-bis[(4-anilino-6-[bis(2-hydroxyethyl)amino]-1,3,5-triazine-2-yl)amino]stilbene-2,2′-disulfonic acid (e.g., available as Tinopal® UNPA from BASF SE), hexasodium-2,2′-[vinylenebis[(3-sulfonato-4,1-phenylene)imino[6-(diethylamino)-1,3,5-triazine-4,2-diyl]imino]]bis-(benzene-1,4-disulfonate) (e.g., available as Tinopal® SFP from BASF SE), 2,2′-(2,5-thiophendiyl)bis[5-1,1-dimethylethyl)-benzoxazole (e.g., available as Tinopal® SFP from BASF SE) and/or 2,5-bis(benzoxazol-2-yl)thiophene.

Suitable color transfer inhibitors include polymers and copolymers of cyclic amines, such as vinylpyrrolidone and/or vinylimidazole. Polymers suitable as dye transfer inhibitors include polyvinylpyrrolidone (PVP), polyvinylimidazole (PVI), copolymers of vinylpyrrolidone and vinylimidazole (PVP/PVI), polyvinylpyridine-N-oxide, poly-N-carboxymethyl-4-vinylpyridium chloride, polyethylene glycol-modified copolymers of vinylpyrrolidone and vinylimidazole, and mixtures thereof. Particularly preferably, polyvinylpyrrolidone (PVP), polyvinylimidazole (PVI) or copolymers of vinylpyrrolidone and vinylimidazole (PVP/PVI) are used as dye transfer inhibitors. The polyvinylpyrrolidones (PVP) used preferably have an average molecular weight of from 2500 to 400000 and are commercially available from ISP Chemicals as PVP K 15, PVP K 30, PVP K 60 or PVP K 90, or from BASF as Sokalan® HP 50 or Sokalan® HP 53. The copolymers of vinylpyrrolidone and vinylimidazole (PVP/PVI) used preferably have a molecular weight in the range of from 5000 to 10,000. A PVP/PVI copolymer is commercially available from BASF under the name Sokalan® HP 56, for example. Other dye transfer inhibitors that can be extremely preferably used are polyethylene glycol-modified copolymers of vinylpyrrolidone and vinylimidazole, which are available from BASF under the name Sokalan® HP 66, for example.

In some embodiments, the agents described herein are preferably pre-packaged into dosing units. These dosing units preferably comprise the amount of washing-active and/or care-active substances necessary for a textile cleaning and/or textile care cycle. In some embodiments, suitable dosing units have a weight between 12 and 30 g, for example. The volume of the aforementioned metering units and the three-dimensional shape thereof are particularly preferably selected so that the pre-packaged units can be metered via the metering chamber of a washing machine. The volume of the dosing unit is therefore preferably between 10 and 35 ml, preferably between 12 and 30 ml.

The detergents, in particular the prefabricated dosage units, particularly preferably have a water-soluble coating. In some embodiments, an agent as described herein is in the form of a unit dose, as previously described. In preferred embodiments, such an agent according to the invention is in particular wrapped in a water-soluble film.

The water-soluble wrapping is preferably made from a water-soluble film material, which is selected from the group consisting of polymers or polymer mixtures. The wrapping may be made up of one or of two or more layers of the water-soluble film material. The water-soluble film material of the first layer and of the additional layers, if present, may be the same or different. Particularly preferred are films which, e.g., can be glued and/or sealed to form packaging, such as tubes or sachets, after they have been filled with an agent. In various embodiments, the films are in the form of multi-chamber pouches.

It is preferable for the water-soluble wrapping to contain polyvinyl alcohol or a polyvinyl alcohol copolymer. Water-soluble wrappings containing polyvinyl alcohol or a polyvinyl alcohol copolymer exhibit good stability with a sufficiently high level of water solubility, in particular cold-water solubility. Suitable water-soluble films for producing the water-soluble wrapping are preferably based on a polyvinyl alcohol or a polyvinyl alcohol copolymer with a molecular weight in the range of from 10000 to 1,000,000 g/mol, preferably from 20,000 to 500,000 g/mol, particularly preferably from 30,000 to 100,000 g/mol, and in particular from 40,000 to 80,000 g/mol. Polyvinyl alcohol is usually prepared by hydrolysis of polyvinyl acetate, since the direct synthesis route is not possible. The same applies to polyvinyl alcohol copolymers, which are prepared accordingly from polyvinyl acetate copolymers. It is preferable for at least one layer of the water-soluble wrapping to include a polyvinyl alcohol of which the degree of hydrolysis is 70 to 100 mol. %, preferably 80 to 90 mol. %, particularly preferably 81 to 89 mol. %, and in particular 82 to 88 mol. %. In addition, a polymer selected from the group comprising (meth)acrylic acid-containing (co)polymers, polyacrylamides, oxazoline polymers, polystyrene sulfonates, polyurethanes, polyesters, polyethers, polylactic acid or mixtures of said polymers may be added to a polyvinyl alcohol-containing film material that is suitable for producing the water-soluble wrapping. Polylactic acids are a preferred additional polymer. Preferred polyvinyl alcohol copolymers include, in addition to vinyl alcohol, dicarboxylic acids as further monomers. Suitable dicarboxylic acids are itaconic acid, malonic acid, succinic acid and mixtures thereof, itaconic acid being preferred. Polyvinyl alcohol copolymers which include, in addition to vinyl alcohol, an ethylenically unsaturated carboxylic acid or the salt or ester thereof, are also preferred. Polyvinyl alcohol copolymers of this kind particularly preferably contain, in addition to vinyl alcohol, acrylic acid, methacrylic acid, acrylic acid ester, methacrylic acid ester or mixtures thereof.

It may be preferable for the film material to contain further additives. The film material can contain plasticizers, such as dipropylene glycol, ethylene glycol, diethylene glycol, propylene glycol, glycerol, sorbitol, mannitol or mixtures thereof, for example. Further additives include, for example, release aids, fillers, crosslinking agents, surfactants, antioxidants, UV absorbers, anti-blocking agents, anti-adhesive agents or mixtures thereof.

Suitable water-soluble films for use in the water-soluble wrappings of the water-soluble packaging according to the invention are films that are sold by MonoSol LLC, e.g., under the names M8630, C8400 or M8900. Other suitable films include films with the name Solublon® PT, Solublon® GA, Solublon® KC or Solublon® KL by Aicello Chemical Europe GmbH or the VF-HP films by Kuraray.

The present invention relates to both manual and mechanical methods for the washing, care or conditioning of textiles.

In particular, the present invention relates to methods for removing hair from textiles and/or the interior of a washing machine, wherein at least one textile detergent and/or textile care agent and/or a textile detergent additive as described herein is placed together with the textiles in a household washing machine or an industrial washing machine and subjected to a washing program so that the hair to be removed can be broken down and/or removed in the washing and/or care process. The combination of active substances according to the invention, i.e., enzyme as defined above, bleaching agent and bleach activator, allows appropriate hair removal even at low temperatures. In various embodiments, a corresponding method therefore comprises treating the textiles, i.e., washing and/or caring for the textiles, with a textile detergent and/or textile care agent and/or a textile detergent additive as described herein, at temperatures in the range from 0 to 90° C., preferably from 20 to 60° C., in particular from 40 to 60° C., e.g., 40° C., 45° C., 50° C., 55° C. or 60° C.

In principle, an agent as described herein can also be used advantageously in combination with other textile detergents and/or care agents in corresponding methods. In various embodiments, the present invention relates in particular to methods in which, in addition to the at least one agent as described herein, a textile conditioner is also used.

The agents described above are intended for use for textile washing and/or textile care purposes as defined herein. Correspondingly, the present invention also relates to the use of a textile detergent and/or textile care agent and/or a textile detergent additive for removing hair from textiles and/or the interior of a washing machine, wherein the agent contains at least one enzyme, at least one bleaching agent and at least one bleach activator. The present invention relates to uses in which a detergent as described herein is used in the washing machine or in a manual textile washing method.

The present invention also relates to the use of a protease for removing hair from textiles and/or the interior of a washing machine, wherein the protease is used in combination with at least one bleaching agent and at least one bleach activator. The aforementioned active substances are preferably constituents of a textile detergent and/or textile care agent and/or textile detergent additive.

All substantive content, subjects and embodiments described for the agents are also applicable to the above subjects of the invention. Therefore, reference is expressly made at this point to the disclosure at the appropriate point with the note that this disclosure also applies to the above-described uses and methods according to the invention.

### EXAMPLES

### Example 1: Detergent and Additive Formulations

TABLE 1
Composition of liquid commercially available
detergent matrix (pH = 8.2-8.6; dosage: 50 ml)

| | Wt. % of active | Wt. % of active |
|---|---|---|
| | substance in | substance in |
| Ingredients | the raw material | the formulation |
| Demineralized water | 100 | To make |
| | | up to 100 |
| Alkylbenzenesulfonic acid (LAS) | 96 | 2-15 |
| Anionic surfactant (FAEOS) | 70 | 3-20 |
| Coconut fatty acid | 30 | 0.3-1 |
| Non-ionic surfactant (FAEO) | 100 | 2-10 |
| Citric acid | 100 | 0.1-2 |
| NaOH | 50 | 0.3-1 |
| Glycerol | 99.5 | 0.3-1 |
| Preservatives (phenoxyethanol | 100 | 0.05-0.1 |
| and BIT) | | |
| Boric acid | 100 | 0-1 |
| Optical brightener | 90 | 0-0.08 |
| (distyrylbiphenyl derivatives or | | |
| other fluorescent brighteners) | | |
| Thickeners (acrylic-based | 25 | 1-3 |
| polymer and co-polymer) | | |
| Enzymes (protease, amylase, | 100 | 0-1 |
| mannanase, lipase, cellulase) | | |
| Complexing agents and builders | 40 | 0.1-2 |
| (e.g., tetrasodium glutamate | | |
| diacetate) | | |
| Dye, perfume, foam inhibitor | 100 | minors |

TABLE 2
Composition of detergent additive containing keratolytic
protease or keratinase (pH = 8-12; dosage: 30-100 g)

| | Wt. % of active | Wt. % of active |
|---|---|---|
| | substance in the | substance in the |
| Ingredients | raw material | formulation |
| Sodium percarbonate | 100 | 10-70 |
| Sodium carbonate | 100 | 10-40 |
| TAED | 100 | 1-12 |
| Sodium sulfate | 100 | 20-70 |
| Enzymes (keratolytic | 100 | 1.5-10 |
| protease or keratinase) | | |
| Perfume | 100 | minor |

### Example 2: Determination of Animal Hair Decomposition on a Small Scale (Qualitative)

Hair: stock coat German Shepherd, gray; approx. 20 mg per batch (+/−1 mg)
Buffer: 100 mM tris/HCl, 0.1% Brij pH 8.6
Reducing agent sodium sulfite: 10% stock solution: 10 g in 100 ml ddH₂O, of which 300 μl in the Eppendorf tube so that a final concentration of 1% sodium sulfite is present (correspondingly in the samples without: add 300 μl ddH₂O)
Enzyme: 1×: 0.7% enzyme raw material; 10×: 7% enzyme raw material

### Procedure (3 ml Batch in Eppendorf Tubes):

A tuft of hair was placed in each case into a 5 ml Eppendorf tube (per tube: 20 mg±1 mg). Then 3 ml of buffer and the corresponding amount of enzyme were added to the tubes. The tubes were incubated at 40° C. with rotation (rotating and shaking) for 18 h. The tubes were then centrifuged for 10 min at 3000 rpm. The supernatant was removed and discarded, and the residue was dried at 70° C. for 2.5 h. The assessment was carried out visually.

TABLE 3
Results of the qualitative assessment

| Protease | Dosage | Result of visual assessment |
|---|---|---|
| Savinase 16 L | 1x | + |
| | 10x | ++ |
| | 10x + reducing agent | +++ |
| Alcalase 2.5 L | 1x | − |
| | 10x | − |
| | 10x + reducing agent | +++ |

### Example 3: Determination of Animal Hair Decomposition on a Small Scale (Quantitative)

Detergent matrix: 2.94 g/l (according to table 1)
Detergent additive: 5.9 g/l (according to table 2, but without enzyme)
Bleach activator (Tinocat LT® B249): 0.0104 g/l (corresponds to 0.16 wt. % based on the total weight of the additive)
Enzyme (Savinase 16 L): 0.64 g/l (corresponds to 9.77 wt. % based on the total weight of the additive)
Animal hair: dog (Golden Retriever) and cat hair 20 mg±1 mg.

The procedure was analogous to example 2.

TABLE 4
Results of the quantitative assessment

| | | | | Hair | Hair |
|---|---|---|---|---|---|
| Detergent | | Enzyme | Bleach activator | decomposition, | decomposition, |
| matrix | Additive | (Savinase 16 L) | (Tinocat LT ® B249) | dog [mg] | cat [mg] |
| 2.94 g/l | 5.9 g/l | — | — | 3.1 | 0.8 |
| 2.94 g/l | 5.9 g/l | 0.64 g/l | — | 8.4 | 2.1 |
| 2.94 g/l | 5.9 g/l | 0.64 g/l | 0.0104 g/l | 10.4 | 3.0 |

### Example 4: Electron-Microscopic Examinations

Gyrowash experiments with 1200 ml beaker
Temperature: 40° C.
Duration: 1 hour with 25 steel balls
Washing liquor volume: 500 ml
Substrate: 0.1 g Golden Retriever hair (dog)
Detergent matrix: 2.94 g/l (according to table 1)
Detergent additive: 5.9 g/l (according to table 2, but without enzyme)
Enzyme (Savinase 16 T): 0.64 g/l (corresponds to 9.79 wt. % based on the total weight of the additive)

Golden Retriever hair was treated with the following washing formulations:

TABLE 5
Series of experiments for electron-microscopic examination

| | | Detergent additives | | |
|---|---|---|---|---|
| | | Benchmark Vamoosh | | |
| | Detergent | (commercial hair | | Savinase |
| Formulation | Matrix | removal product) | Additive | 16 T |
| 1 | 2.94 g/l | 5.9 g/l | — | — |
| 2 | 2.94 g/l | — | — | 0.64 g/l |
| 3 | 2.94 g/l | — | 5.9 g/l | 0.64 g/l |

The washing liquor was filtered using a filtration cascade in the following stages:
60, 25, 10, 5 μm stainless steel filter and vacuum pump

A self-built four-stage filter cascade was used to filter the washing liquor. The device is a horizontally stacked stainless steel cascade that allows fractional filtration. This facilitates filtration and allows an estimate of the particle size distribution. The individual stages can be screwed together so that the number of filtration stages can be adapted to individual needs. Each stage contains removable stainless steel filters that can be flexibly used for subsequent analyses, such as microscopy and gravimetric measurements. For each filtration process, four stainless steel filters with a diameter of 47 mm were used, with the pore size being used in decreasing order from 60 μm (plain weave) to 25 μm (plain weave), 10 μm (plain weave) and 5 μm filters (twill weave). All filters were manufactured by Rolf Korner GmbH and pre-cleaned in an ultrasonic bath. A total of three silicone sealing rings were used per stainless steel filter. A vacuum pump (PC 3001 VARIO Vacuubrand) was connected to the filter cascade. The vacuum pump worked at 250 mbar. For filtration, the washing liquor was introduced into the upper funnel. After filtration of the washing liquid, the cascade was additionally rinsed with distilled water.

The resulting filter cake was analyzed by scanning electron microscopy. The SEM images (see FIG. 1) in backscattered electron mode (correlates with material contrast) show a normal hair structure with intact scales in hair treated with formulation 1 (Benchmark) (a, b, c). Formulation 1 differs little from formulation 2 (d-f). However, the hair treated with formulation 3 (g-i) shows clear differences in structure and an overall damaged surface (g). Additionally, fractures (h) and angled scales (i) can be seen. The combination of the additive containing bleaching agent and bleach activator with the enzyme Savinase 16 T achieves the best results.

1. A method for removing hair, the method comprising:
using a cleaning composition comprising at least one protease, at least one bleaching agent, and at least one bleach activator.

2. The method of claim 1, wherein the at least one protease is selected from the group consisting of proteases with keratolytic activity.

3. The method of claim 1, wherein the at least one protease is present in an amount of from 1.5 to 20 wt. %, based on the total weight of the cleaning composition.

4. The method of claim 1, wherein the at least one bleaching agent does not include chlorine.

5. The method of claim 1, wherein the at least one bleaching agent is selected from the group consisting of peroxygen compounds.

6. The method of claim 1, wherein the at least one bleaching agent is present in an amount of from 5 to 70 wt. %, based on the total weight of the cleaning composition.

7. The of claim 1, wherein the at least one bleach activator is present in an amount of from 0.3 to 15 wt. %, based on the total weight of the cleaning composition.

8. The method of claim 1, wherein the at least one bleach activator is selected from the group consisting of bleach activator compounds that yield peroxocarboxylic acid under perhydrolysis conditions, bleach activator compounds that form perimidic acid under perhydrolysis conditions, and bleach-activating transition metal complexes and acylhydrazones.

9. The method of claim 1, wherein the at least one bleach activator is selected from the group consisting of polyacylated alkylenediamines, acylated glycolurils, acylated triazine derivatives, N-acylimides, acylated phenol sulfonates or carboxylates or the sulfonic or carboxylic acids thereof, acylated polyhydric alcohols, acylated sugar derivatives, and N-acylated lactams.

10. The method of claim 1, wherein the weight ratio of the at least one bleaching agent to the at least one bleach activator is from 5:1 to 15:1.

11. The method of claim 1, wherein the cleaning composition further comprises at least one of fragrances, surfactants, builders, additives for adjusting viscosity and/or for stabilization, UV stabilizers, dyes, pearlescent agents, preservatives, bitter substances, organic salts, disinfectants, polymers, defoamers, or pH adjusters.

12. The method of claim 1, wherein the cleaning composition is used at a temperature of from 0 to 90 C.

13-14. (canceled)

15. The method of claim 1, wherein the hair is removed from textiles and/or an interior of a washing machine.

16. The method of claim 1, wherein the cleaning composition comprises a textile detergent, a textile care agent, and/or a textile detergent additive.

17. The method of claim 2, wherein the at least one protease is selected from the group consisting of keratinases.

18. The method of claim 3, wherein the at least one protease is present in an amount of from 2.0 to 15 wt. %, based on the total weight of the cleaning composition.

19. The method of claim 5, wherein the at least one bleaching agent is selected from the group consisting of percarboxylic acid, dodecanediperic acid, phthaloylaminoperoxicaproic acid, hydrogen peroxide, alkali metal perborate, percarbonate, perpyrophosphate, and persilicate.

20. The method of claim 9, wherein the at least one bleach activator is selected from the group consisting of tetraacetylethylenediamine, tetraacetylglycoluril, 1,5-diacetyl-2,4-dioxohexahydro-1,3,5-triazine, N-nonanoylsuccinimide, nonanoyl sulfonate, isononanoyl sulfonate, lauroyl oxybenzene sulfonate, decanoyloxybenzoate, 4-(2-decanoyloxyethoxycarbonyloxy)benzene sulfonate, triacetin, ethylene glycol diacetate, 2,5-diacetoxy-2,5-dihydrodrofuran, acetylated sorbitol and mannitol and mixtures thereof, pentaacetylglucose, pentaacetylfructose, tetraacetylxylose, and acetylated octaacetyl lactose, N-alkylated glucamine and gluconolactone, and N-benzoyl-caprolactam.

21. The method of claim 10, wherein the weight ratio of the at least one bleaching agent to the at least one bleach activator is approximately 10:1.

22. The method of claim 11, wherein the cleaning composition is used at a temperature of from 40 to 60° C.
